(19) United States
(12) Patent Application Publication
(10) Pub. No.: US 2013/0140464 A1
(43) Pub. Date: Jun. 6, 2013

(54) RADIATION DETECTION PANEL

(71) Applicant: FUJIFILM CORPORATION, Tokyo (JP)

(72) Inventors: Naoto IWAKIRI, Ashigarakami-gun (JP); Yasunori OHTA, Ashigarakami-gun (JP); Haruyasu NAKATSUGAWA, Ashigarakami-gun (JP); Naoyuki NISHINOU, Ashigarakami-gun (JP)

(73) Assignee: FUJIFILM CORPORATION, Tokyo (JP)

(21) Appl. No.: 13/744,434

(22) Filed: Jan. 18, 2013

Related U.S. Application Data
(63) Continuation of application No. PCT/JP2011/059744, filed on Apr. 20, 2011.

(30) Foreign Application Priority Data
Jul. 26, 2010 (JP) 2010-166962

(51) Int. Cl. G01T 1/20

(52) U.S. Cl. CPC G01T 1/2006
USPC 250/366

(57) ABSTRACT

A radiation detection panel includes a single light emitting section, a first detection section and a second detection section. The single light emitting section absorbs radiation that has been transmitted through an imaging subject and that emits light. The first detection section detects light emitted from the light emitting section as an image. The second detection section that is formed from an organic photoelectric conversion material and that detects light emitted from the light emitting section. The light emitting section, the first detection section and the second detection section are stacked in layers along a radiation incident direction.

### CROSS-REFERENCE TO RELATED APPLICATIONS

This application is a continuation application of International Application No. PCT/JP/2011/059744, filed on Apr. 20, 2011, which is incorporated herein by reference. Further, this application claims priority from Japanese Patent Application No. 2010-166962, filed on Jul. 26, 2010, which is incorporated herein by reference.

### BACKGROUND OF THE INVENTION

1. Field of the Invention

The present invention relates to a radiation detection panel, and in particular to a radiation detection panel equipped with a light emitting section that absorbs radiation that has been transmitted through an imaging subject and emits light, and a detection section that detects light emitted from the light emitting section as an image.

2. Description of the Related Art

Recently, Flat Panel Detectors (FPD) are being put into practice, which detects radiation such as X-rays, gamma (γ) rays and alpha (α) rays irradiated on a radiation sensitive layer disposed on a Thin Film Transistor (TFT) active matrix substrate, and directly converts the radiation into data of a radiographic image expressing a distribution of irradiated radiation amounts. Portable radiation detection panels (referred to below as electronic cassettes) are also being put into practice, which are installed with a panel type radiation detector such as these FPDs, electronic circuits including an image memory, and a power source unit, and stores radiographic image data output from the radiation detector in the image memory. As the above radiation sensitive layer, a configuration adopting indirect conversion methods is known, in which irradiated radiation is first converted into light by a scintillator (phosphor layer) such as CsI: Tl, GOS (Gd₂O₂S:Tb), then the light emitted from the scintillator is further converted into electric charge by a light detection section configured, for example, from a photodiode (PD), and the electric charge are accumulated. Due to the excellent portability, such radiation detection panels are capable of flexible application to cases of imaging a subject who cannot move, since it is possible to perform imaging of a subject lying on a stretcher or bed, and it is easy to adjust the image capture site by changing the position of the radiation detection panel.

However, with radiation detection panels adopting indirect conversion methods, in order to maintain the quality of captured images, it is necessary to detect the initiation of image capture (the time when radiation application onto the radiation detection panel has been started), to reset unwanted electric charges that have been accumulated over time due to dark current (the current generated, for example, due to re-emission of charge temporarily trapped in impurity state of amorphous silicon) in photoelectric conversion elements such as PDs before image capture, and then to start image capture (charge accumulation). The detection of initiation of image capture (or termination of image capture) in the radiation detection panel is generally achieved by connecting a radiation source and the radiation detection panel by a signal line in order to give notification of initiation of image capture (or termination of image capture) from the radiation source to the radiation detection panel. However, since a configuration in which the radiation detection panel is connected to the radiation source by a signal line will deliver a detrimental effect on ease of handling of the radiation detection panel, it is preferable to incorporate in the radiation detection panel a function of detecting radiation application by the radiation detection panel itself.

In relation to the above, Japanese Patent Application Laid-Open (JP-A) No. 2002-181942 (referred to below as Patent Document 1) describes a technique that realizes omission of a wiring line between a radiation source and a radiographic image capture device. The technique is realized by a radiographic image capture device provided with a solid state image capture device including a conversion section that converts radiation emitted from the radiation source into electrical signals, an accumulation section that accumulates the converted electrical signals, and a read section that reads the accumulated electrical signals, wherein the radiographic image capture device is further provided with radiation detection elements that detect the start and end of irradiation of radiation from the radiation source, and a controller that controls a drive circuit driving the accumulation section or the read section according to the detection result of the radiation detection elements.

Further, JP-A No. 2009-32854 (referred to below as Patent Document 2) discloses a radiographic image capture element including, a phosphor layer that emits light on absorption of radiation that has been transmitted through an imaging subject, an upper electrode, a lower electrode, a photoelectric conversion layer equipped with a photoelectric conversion section interposed between the upper and lower electrodes and a field effect thin film transistor, and a signal output section that outputs signals according to the charges generated by the photoelectric conversion section, wherein all of these elements are layered in sequence on a substrate. The photoelectric conversion section is configured with an organic photoelectric conversion material that absorbs light emitted by the phosphor layer.

As described above, in cases of attempting to incorporate a function to detect the initiation time of radiation application (or the termination time of application) into a radiation detection panel, a new radiation detection section for detecting radiation irradiated onto the radiation detection panel needs to be provided to the radiation detection panel, such as the radiation detection element described in the Patent Document 1, separate from the configuration for detecting, as an image, radiation that has been irradiated onto the radiation detection panel. Further, there is also a requirement to incorporate a function in the radiation detection panel for detecting irradiation amount of radiation (or the cumulative value thereof) of the radiation detection panel for the objective such as limiting the cumulative irradiation amount of radiation applied to the imaging subject. A new radiation detection section as described above also needs to be provided to the radiation detection panel in order to satisfy this requirement.

However, in the technology of Patent Document 1, due to the radiation detection elements being provided on the side of the phosphor member and detector (at one end portion along the radiation irradiation face), issues arise in that the size of the radiation detection panel along the radiation irradiation face is made larger, and there is a detrimental effect on ease of handling of the radiation detection panel. Moreover, the technology described in Patent Document 1 has the disadvantages that, due to the disposition of the radiation detection elements, radiation incident to the radiation detection elements may be readily blocked by obstacles, and, therefore, radiation cannot be detected, and it is also difficult to detect the radiation amount that has been transmitted through the imaging subject.

Instead of the above configuration, it is conceivable to adopt a configuration in which a new radiation detection section, the light emitting section that absorbs radiation and emits light, and the detection section that detects the light emitted from this light emitting section as an image, are stacked along the radiation incident direction. However, in such a case, the thickness of the radiation detection panel would be significantly increased, which causes the issue of deterioration in ease of handling of the radiation detection panel.

### SUMMARY

The present invention has been arrived at in consideration of the above circumstances, and an object thereof is to provide a radiation detection panel that realizes a configuration including a function of detecting irradiation of radiation separately, in addition to the function of detecting irradiated radiation as an image, without leading to increase in the panel size or a significant increase in thickness.

In order to achieve the above object, a radiation detection panel according to a first aspect of the present invention includes, a single light emitting section that absorbs radiation that has been transmitted through an imaging subject and that emits light; a first detection section that detects light emitted from the light emitting section as an image; and a second detection section that is formed from an organic photoelectric conversion material and that detects light emitted from the light emitting section, wherein, the light emitting section, the first detection section and the second detection section are stacked in layers along a radiation incident direction.

The first aspect of the present invention is provided with the light emitting section that absorbs radiation that has been transmitted through an imaging subject and emits light, the first detection section that detects light emitted from the light emitting section as an image, and the additional second detection section that is formed from an organic photoelectric conversion material and that detects light emitted from the light emitting section. A function of detecting irradiated radiation as an image is realized by the first detection section, and a function of detecting irradiation of radiation is realized by the second detection section.

The radiation detection panel according to the first aspect of the present invention is configured such that the light emitting section, the first detection section and the second detection section are stacked in layers along the radiation incident direction. Therefore, an increase in the panel size along a direction substantially orthogonal to the radiation incident direction due to provision of the second detection section can be prevented. The second detection section formed from an organic photoelectric conversion material can also be manufactured by applying an organic photoelectric conversion material onto a support substrate using a liquid droplet jetting head such as an inkjet head. This enables the second detection section to be formed on the support member with lower strength and heat resistance than in a case in which the second detection section is formed using a material (for example silicon) requiring vapor deposit for manufacture, thereby enables the thickness of the support member to be made thin. Increase in the thickness can accordingly be suppressed even for the configuration in which the light emitting section, the first detection section and the second detection section are stacked in layers along the radiation incident direction.

Consequently, according to the first aspect of the present invention, configuration provided with a function of detecting irradiation of radiation separately from a function of detecting irradiated radiation as an image can be realized without leading to increase in a panel size or a significant increase in thickness.

A second aspect of the present invention is the first aspect of the present invention, wherein the first detection section and the second detection section are provided on a same support member. The thickness of the panel can accordingly be made thinner due to a reduction in the number of support members in comparison to cases where support members corresponding to the first detection section and the second detection section are provided individually.

A third aspect of the present invention is the first aspect of the present invention or the second aspect of the present invention wherein a member present between the single light emitting section and the first detection section, and another member present between the single light emitting section and the second detection section, each member having light transmitting properties enabling transmission of at least a portion of irradiated light. The light emitted from the light emitting section is thus detected respectively by the first detection section and the second detection section, and the light emitting section is made common for both the first detection section and the second detection section. Accordingly, there is no need to provide plural light emitting sections in order to provide the second detection section, and the thickness of the panel can be further prevented from increasing.

A fourth aspect of the present invention is any one of the first aspect of the present invention to the third aspect of the present invention, wherein the first detection section is formed on a support member that has a plate shape and light transmitting properties, the light emitting section is layered on one face of the plate shaped support member, the second detection section is layered on the other face of the support member, and the support member is disposed such that radiation is incident from a side of the second detection section. In the above configuration, due to the first detection section, the second detection section and the light emitting section being supported by a single plate shaped support member, the thickness of the panel can be made thinner than in cases where at least one of the first detection section, the second detection section or the light emitting section are supported by a separate different support member. Further, since the first detection section and the second detection section are disposed on the radiation incident side of the light emitting section, the light detection efficiency of the first detection section and the second detection section is improved.

A fifth aspect of the present invention is any one of the first aspect of the present invention to the fourth aspect of the present invention, wherein at least the support member on which the second detection section is disposed is a substrate made with a synthetic resin. Although the substrate made from a synthetic resin has a lower temperature resistance than a substrate made for example from glass, the synthetic resin substrate is readily made thinner and, therefore, the thickness of the panel can be made even thinner by employing the synthetic resin substrate as the support member on which the second detection section is disposed. Note that it is possible to employ the synthetic resin substrate as the support member in the fourth aspect of the present invention by respectively configuring the first detection section and the light emitting section of the fourth aspect of the present invention with material not requiring vapor deposition during manufacture (for example, forming the first detection section with an organic photoelectric conversion material and forming the light emitting section with GOS (Gd₂O₂S:Tb).

A sixth aspect of the present invention is any one of the first aspect of the present invention to the fifth aspect of the present invention wherein: the first detection section is equipped with plural photoelectric conversion elements arrayed two-dimensionally; and the second detection section is disposed between the light emitting section and the first detection section, and is disposed in a range that does not block light that is emitted from the light emitting section and that is incident at any of the plural photoelectric conversion elements. Accordingly, the light incident to the photoelectric conversion elements of the first detection section can be prevented from being blocked by the second detection section disposed between the light emitting section and the first detection section. Light emitted from the light emitting section can accordingly be detected as an image with good precision by the first detection section even in a configuration in which the second detection section is disclosed between the light emitting section and the first detection section.

A seventh aspect of the present invention is any one of the first aspect of the present invention to the sixth aspect of the present invention further including a first controller that performs a first control, of synchronizing a timing of detection of light by the first detection section with a timing of irradiation of radiation at the radiation detection panel, based on a result of light detection by the second detection section. Accordingly, there is no need for providing an external device to give notification of the irradiation timing of radiation to the radiation detection panel, and the synchronization of the detection timing of light by the first detection section with the irradiation timing of radiation to the radiation detection panel can be realized with the radiation detection panel alone.

An eighth aspect of the present invention is the seventh aspect of the present invention wherein the first detection section includes a photoelectric conversion section that converts light emitted from the light emitting section into an electrical signal, and a charge accumulation section that accumulates as charge the electrical signal that has been output from the photoelectric conversion section; and the first controller causes, as the first control, the first detection section to start accumulation of charge in the charge accumulation section from a state in which an electrical signal that has been previously output from the photoelectric conversion section has not been accumulated as charge in the charge accumulation section, at least in a case in which light emitted from the light emitting section is detected by the second detection section.

A ninth aspect of the present invention is the eighth aspect of the present invention wherein the first controller causes, as the first control, the first detection section to start reading the charge accumulated in the charge accumulation section of the first detection section, if light emitted from the light emitting section is no longer being detected by the second detection section.

A tenth aspect of the present invention is any one of the first aspect of the present invention to the seventh aspect of the present invention further including a second controller that performs a second control, of terminating radiation irradiation from a radiation source if a cumulative irradiation amount of radiation at the radiation detection panel has reached a specific value, based on a result of light detection by the second detection section. Control of terminating irradiation of radiation from the radiation source if the cumulative irradiation amount of radiation to the radiation detection panel has reached the specific value can accordingly be realized without providing a separate detection section for detecting the cumulative irradiation amount of radiation to the radiation detection panel.

An eleventh aspect of the present invention is the tenth aspect of the present invention wherein as the second control, the second controller computes a cumulative irradiation amount of radiation at the radiation detection panel based on the result of light detection by the second detection section, repeatedly determines whether or not the computation result of the cumulative irradiation amount has reached the specific value, and outputs a signal indicating that the cumulative irradiation amount of radiation has reached the specific value if a determination is made that the computation result of the cumulative irradiation amount has reached the specific value.

A twelfth aspect of the present invention is the eleventh aspect of the present invention wherein the second controller outputs an instruction signal instructing termination of radiation irradiation from the radiation source to a control device controlling the radiation irradiation from the radiation source, as the signal indicating that the cumulative irradiation amount of radiation has reached the specific value.

As explained above, the present invention includes a light emitting section that absorbs radiation that has been transmitted through an imaging subject and emits light, a first detection section that detects light emitted from the light emitting section as an image, and a second detection section that is formed from an organic photoelectric conversion material and that detects light emitted from the light emitting section, and these are stacked in layers along the radiation incident direction. The excellent advantageous effect is accordingly exhibited, which enables a configuration provided with a function of detecting irradiation of radiation separately from a function of detecting irradiated radiation as an image to be realized without leading to increase in the panel size or a significant increase in thickness.

### BRIEF DESCRIPTION OF THE DRAWINGS

Detailed explanation follows regarding an example of an exemplary embodiment of the present invention, with reference to the drawings.

FIG. 1 is a block diagram illustrating a configuration of a radiology information system explained in an exemplary embodiment.

FIG. 2 is a side view illustrating an example of the placement of each device in a radiographic image capture room in a radiographic image capture system.

FIG. 3 is a perspective view illustrating an electronic cassette in a partially cut-away state.

FIG. 4 is a cross-sectional view schematically illustrating a configuration of a radiation detector.

FIG. 5 is a cross-sectional view illustrating a configuration a thin film transistor and a capacitor of the radiation detector.

FIG. 6 is a plan view illustrating a configuration of a TFT substrate.

FIG. 7 is a block diagram illustrating a configuration of relevant portions of an electrical system of the electronic cassette.

FIG. 8 is a block diagram illustrating a configuration of relevant portions of an electrical system of a console and a radiation generator.

FIG. 9 is a flow chart illustrating details of image capture control processing.

FIG. 10A is a schematic view illustrating a variation on the schematic configuration of the electronic cassette.

FIG. 10B is a schematic view illustrating a variation on the schematic configuration of the electronic cassette.

FIG. 10C is a schematic view illustrating a variation on the schematic configuration of the electronic cassette.

FIG. 10D is a schematic view illustrating a variation on the schematic configuration of an electronic cassette.

FIG. 10E is a schematic view illustrating a variation on the schematic configuration of the electronic cassette.

FIG. 11 is a perspective view schematically illustrating an example of a light receiving region of the radiation detector and a light receiving region of a radiation detection section in a case in which the radiation detection section is disposed between a scintillator and the radiation detector.

FIG. 12A is a schematic view illustrating a variation on the schematic configuration of the electronic cassette.

FIG. 12B is a schematic view illustrating a variation on the schematic configuration of the electronic cassette.

FIG. 12C is a schematic view illustrating a variation on the schematic configuration of the electronic cassette.

FIG. 12D is a schematic view illustrating a variation on the schematic configuration of the electronic cassette.

FIG. 12E is a schematic view illustrating a variation on the schematic configuration of the electronic cassette.

FIG. 13A is a schematic view illustrating a variation on the schematic configuration of the electronic cassette.

FIG. 13B is a schematic view illustrating a variation on the schematic configuration of the electronic cassette.

FIG. 13C is a schematic view illustrating a variation on the schematic configuration of the electronic cassette.

FIG. 13D is a schematic view illustrating a variation on the schematic configuration of the electronic cassette.

FIG. 13E is a schematic view illustrating a variation on the schematic configuration of the electronic cassette.

FIG. 14A is a schematic view illustrating a variation on the schematic configuration of the electronic cassette.

FIG. 14B is a schematic view illustrating a variation on the schematic configuration of the electronic cassette.

FIG. 14C is a schematic view illustrating a variation on the schematic configuration of the electronic cassette.

FIG. 14D is a schematic view illustrating a variation on the schematic configuration of the electronic cassette.

FIG. 14E is a schematic view illustrating a variation on the schematic configuration of the electronic cassette.

### DETAILED DESCRIPTION

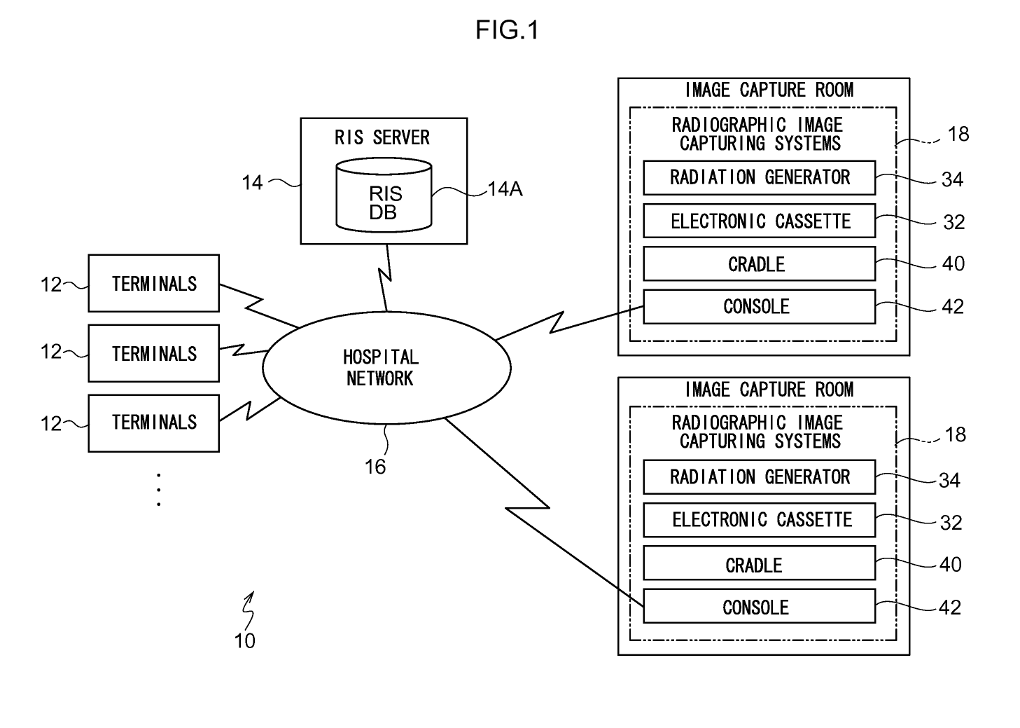

FIG. 1 shows a radiology information system 10 (referred to hereafter as “RIS 10”) according to the present exemplary embodiment. The RIS 10 is a system for managing data such as medical appointments and diagnostic records in a hospital radiology department. The RIS 10 includes plural terminals 12, an RIS server 14 and radiographic image capturing systems 18 (including consoles 42) installed in individual radiographic image capturing rooms (or operating rooms) in a hospital, each connected to a hospital network 16 that is configured by a wired or wireless local area network (LAN). The RIS 10 configures part of a hospital information system (HIS) in the same hospital, and an HIS server (not shown in the drawings) that manages the overall HIS is also connected to the hospital network 16.

Each of the terminals 12 is configured by, for example, a personal computer (PC) operated by doctors or radiologists. The doctors or radiologists input or browse diagnostic information and facility reservations through the terminals 12. Radiographic image capture requests (image capture reservations) are also input through the terminals 12. The RIS server 14 is a computer including a storage section 14A that stores an RIS database (DB). The RIS database stores patient attribute data (such as the name, sex, date of birth, age, blood type and patient ID of the patient) as well as other information relating to the patient, for example, medical history, consultation history, radiographic image capture history, and radiographic image data from past image capture. The RIS database also stores information relating to electronic cassettes 32 (described later) of the individual radiographic image capturing systems 18 (for example identification number, type, size, sensitivity, possible image capture sites (i.e., possible image capture requests), date of first use, number of uses). The RIS server 14 performs processing for overall management of the RIS 10 (for example, accepting image capture requests from each of the terminals 12, or managing radiographic image capture schedules for the individual radiographic image capturing systems 18) based on the information stored in the RIS database.

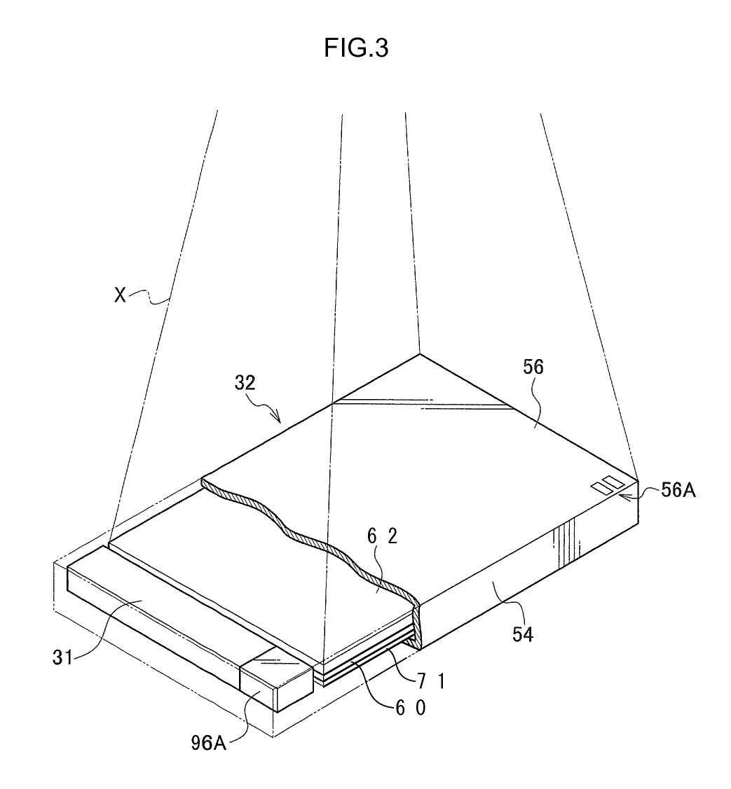

Each of the radiographic image capturing systems 18 is a system that captures radiographic images as instructed by the RIS server 14, according to operation by doctors or radiologists. Each of the radiographic image capturing systems 18 is equipped with a radiation generator 34 that generates radiation with which the patient (imaging subject) is irradiated, an electronic cassette 32 installed with a radiation detector that detects radiation that has been transmitted through the patient and converts the radiation into radiographic image data for output, a cradle 40 that charges a battery 96A (see FIG. 3) installed in the electronic cassette 32, and the console 42 that controls the operation of each of the devices described above. Note that the electronic cassette 32 is an example of a radiation detection panel according to the present invention.

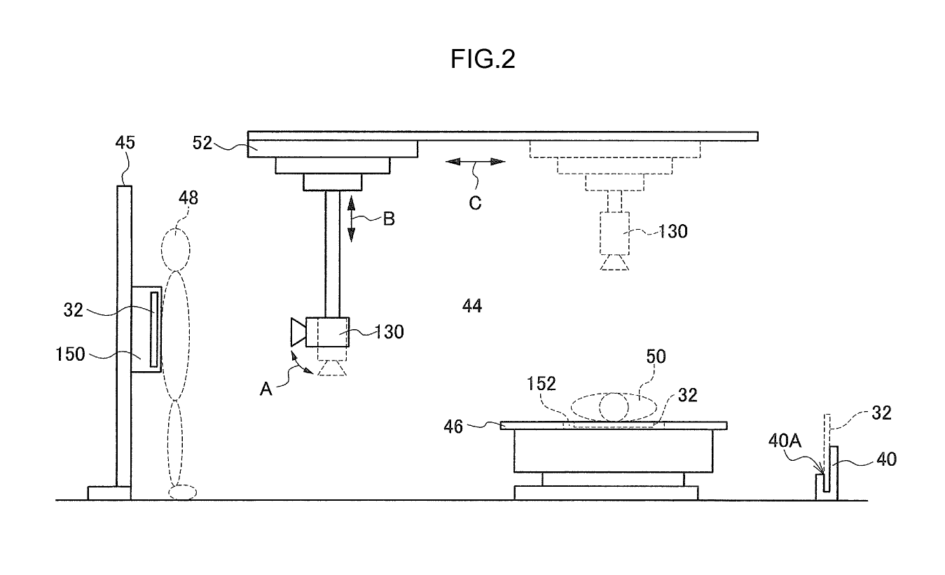

As illustrated in FIG. 2, a radiation source 130 (described in detail later) of the radiation generator 34 is disposed in a radiographic image capture room 44, together with an upright stand 45 employed in a case in which upright radiographic image capture is performed and a lying table 46 employed in a case in which radiographic image capture is performed in lying posture. An image capture position 48 of the imaging subject for performing upright radiographic image capture is located in space in front of the upright stand 45, and an image capture position 50 of the imaging subject for performing radiographic image capture in lying posture is located in space above the lying table 46. A holder 150 for holding the electronic cassette 32 is provided to the upright stand 45, and the electronic cassette 32 is held by the holder 150 during upright radiographic image capture. The electronic cassette 32 is placed on a top plate 152 of the lying table 46 during lying radiographic image capture.

In order to enable upright radiographic image capture and lying radiographic image capture with radiation from a single radiation source 130, a movable support mechanism 52 is provided in the radiographic image capture room 44 to support the radiation source 130, and to enable rotation about a horizontal axis (in the arrow A direction in FIG. 2), enable movement in a vertical direction (in the arrow B direction in FIG. 2), and enable movement in a horizontal direction (in the arrow C direction in FIG. 2). The movable support mechanism 52 is equipped with a drive source for rotating the radiation source 130 about the horizontal axis, a drive source for moving the radiation source 130 in the vertical direction, and a drive source for moving the radiation source 130 in the horizontal direction (these are not illustrated in the drawings). If standing posture is specified for the image capture posture in imaging condition data, the movable support mechanism 52 moves the radiation source 130 to an upright imaging position (a position for irradiating a patient with emitted radiation from the side of the patient positioned at the image capture position 48). If lying posture is specified for the image capture posture instructed in the imaging condition data, the movable support mechanism 52 moves the radiation source 130 to a lying imaging position (a position for irradiating a patient with emitted radiation from above the patient positioned at image capture position 50).

A housing 40A capable of housing the electronic cassette 32 is formed in the cradle 40. The electronic cassette 32 is housed in the housing 40A of the cradle 40 when the electronic cassette 32 is not in use, and charging is performed to the internal battery by the cradle 40 in this state. The electronic cassette 32 is taken out from the cradle 40 for example by a radiologist when a radiographic image is to be captured, and held in the holder 150 of the upright stand 45 for image capture in upright posture or placed on the top plate 152 of the lying table 46 for image capture in lying posture. The electronic cassette 32 is not limited to being disposed at either of the above two types of position, and due to its portability the electronic cassette 32 may obviously be disposed at any desired position in the radiographic image capture room 44 during radiographic image capture.

Explanation follows regarding the electronic cassette 32. As shown in FIG. 3, the electronic cassette 32 is provided with a rectangular box shaped casing 54 formed from a material that transmits radiation X, and formed with a rectangular shaped irradiation face 56 onto which the radiation X is irradiated. Blood or other contaminants might sometimes adhere to the electronic cassette 32 when the electronic cassette 32 is used for example in an operating room. The electronic cassette 32 is accordingly configured with a structure that is hermetically sealed and waterproofed by the casing 54, such that the same electronic cassette 32 can be disinfected as required and reused repeatedly.

Disposed inside the casing 54 of the electronic cassette 32 are a radiation detection section 62 serving as an example of the second detection section of the present invention, a radiation detector 60 serving as an example of the first detection section of the present invention, and a scintillator 71 serving as an example of the light emitting section of the present invention, which are stacked in layers from the side of the radiation X irradiation face 56 of the casing 54 in sequence along the incident direction of the radiation X that has been transmitted through the imaging subject. A case 31 that houses various electronic circuits, including a microcomputer and the detachable and rechargeable battery 96A, is also disposed inside the casing 54 at one end side of the longitudinal direction of the irradiation face 56. The radiation detector 60 and the various electronic circuits described above are operated by electric power supplied from the battery 96A housed within the case 31. A radiation shielding member, formed for example by a lead plate, is provided at the irradiation face 56 side of the case 31 inside the casing 54 in order to avoid damage to the various electronic circuits housed within the case 31 due to irradiation of the radiation X.

A display section 56A including plural individual LEDs is provided on the irradiation face 56 of the casing 54. The display section 56A displays operation states, such as the operation mode of the electronic cassette 32 (for example “ready” or “transmitting data”) or the remaining capacity of the battery 96A. Note that the display section 56A may be configured from light emitting elements other than LEDs, and may be configured by a display section of a liquid crystal display or an organic electro luminescence (EL) display. The display section 56A may also be provided at a location other than the irradiation face 56.

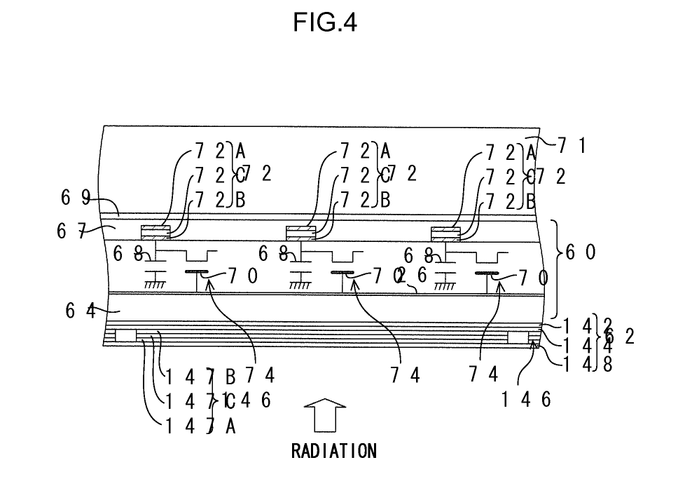

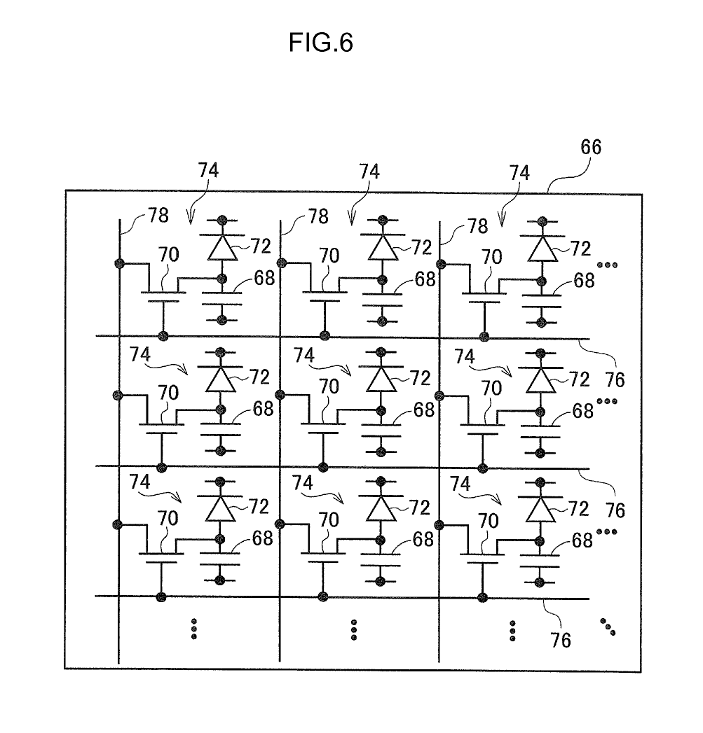

As illustrated in FIG. 4, the radiation detector 60 includes pixels 74, each equipped with a photoelectric conversion section 72 formed for example from photodiodes (PDs), a Thin Film Transistor (TFT) 70, and a storage capacitor 68. As illustrated in FIG. 6, the radiation detector 60 is configured as a TFT active matrix substrate (referred to below as “TFT substrate”) with the plural pixels 74 formed in a matrix pattern on an insulating substrate 64 that is flat plate shaped with a rectangular shaped external profile in plan view.

Each of the photoelectric conversion sections 72 is configured with a photoelectric conversion layer 72C that absorbs light emitted from the scintillator 71 and generates electric charge according to the absorbed light, which is disposed between an upper electrode 72A and a lower electrode 72B.

The upper electrode 72A is preferably configured by a conducting material that has a high transmittance at least for light of the emission wavelength of the scintillator 71 since it is necessary for light emitted by the scintillator 71 to be incident on the photoelectric conversion layer 72C. More specifically, preferably a transparent conducting oxide (TCO) with high transmittance to visible light and low resistance is employed for the upper electrode 72A. A metal thin film, such as of Au, may also be used as the upper electrode 72A. However, TCO is preferable since the resistance of a metal thin film is liable to increase in cases of trying to obtain a transmittance of 90% or more. Examples of materials preferably employed include ITO, IZO, AZO, FTO, SnO₂, TiO₂ and ZnO₂. ITO is most preferred from the standpoints of ease of processing, low resistance, and transparency. The upper electrode 72A may be configured as a single layer common to all pixels or may be divided per pixel.

The photoelectric conversion layer 72C may be configured from any material that generates electric charge in response to absorption of light, and may, for example, be formed from amorphous silicon or an organic photoelectric conversion material. In a case in which the photoelectric conversion layer 72C is formed from amorphous silicon, a configuration can be achieved wherein light emitted by the scintillator 71 is absorbed over a wide wavelength region. However, vapor deposition is required to form a photoelectric conversion layer 72C made from amorphous silicon, and if the insulating substrate 64 is made from a synthetic resin, the heat resistance of the insulating substrate 64 may be insufficient.

In a case in which the photoelectric conversion layer 72C is formed from a material including an organic photoelectric conversion material, a wavelength absorption spectrum with high absorption of waves mainly in the visible region is obtained, and virtually no electromagnetic wave other than the light emitted by the scintillator 71 is absorbed by the photoelectric conversion layer 72C. Therefore, noise generated as a result of radiation such as X-rays or gamma (γ) rays being absorbed by the photoelectric conversion layer 72C can be reduced. Further, the photoelectric conversion layer 72C formed from an organic photoelectric conversion material can be formed by adhering an organic photoelectric conversion material to a base material using a liquid droplet jetting head such as an inkjet head, and heat resistance is not required for the base material in this case. For these reasons, in the present exemplary embodiment, the photoelectric conversion layers 72C of the photoelectric conversion section 72 are formed with an organic photoelectric conversion material.

Hardly any radiation is absorbed in the photoelectric conversion layer 72C if the photoelectric conversion layer 72C is formed from an organic photoelectric conversion material. Therefore, in cases of adopting an Irradiation Side Sampling (ISS) method in which the radiation detector 60 is disposed at a side that radiation passes through, radiation attenuation due to passing through the radiation detector 60 can be reduced, and it is possible to prevent a drop in sensitivity to radiation of the radiation detector 60. Hence, forming the photoelectric conversion layer 72C from an organic photoelectric conversion material is particularly preferable in Irradiation Side Sampling (ISS) methods.

The absorption peak wavelength of the organic photoelectric conversion material forming the photoelectric conversion layer 72C is preferably as close as possible to the emission peak wavelength of the scintillator 71 so that the organic photoelectric conversion material most efficiently absorbs the light emitted by the scintillator 71. Ideally the absorption peak wavelength of the organic photoelectric conversion material and the emission peak wavelength of the scintillator 71 coincide with each other. However, the organic photoelectric conversion material can sufficiently absorb the light emitted from the scintillator 71 as long as any difference therebetween is small. More specifically, the difference between the absorption peak wavelength of the organic photoelectric conversion material and the emission peak wavelength of the scintillator 71 with respect to radiation is preferably within 10 nm, and more preferably within 5 nm.

Examples of organic photoelectric conversion materials capable of satisfying this condition include quinacridone organic compounds and phthalocyanine organic compounds. For example, the absorption peak wavelength in the visible region of quinacridone is 560 nm. It is accordingly possible to make the difference between respective peak wavelengths within 5 nm if quinacridone is used as the organic photoelectric conversion material and CsI:Tl (cesium iodide doped with thallium) is used as the material of the scintillator 71, and substantially the maximum charge amount can be generated in the photoelectric conversion layer 72C. Detailed description of materials applicable as the organic photoelectric conversion material in the photoelectric conversion layer 72C is given in JP-A No. 2009-32854, and further description is omitted herein.

More specific explanation follows regarding the photoelectric conversion layer 72C applicable to the radiation detector 60. Electromagnetic wave absorption/photoelectric conversion locations in the radiation detector 60 are configured by the electrodes 72A, 72B and an organic layer that includes the photoelectric conversion layer 72C disposed between the electrodes 72A, 72B. More specifically, the organic layer can be formed by stacking or mixing sites such as: a site where electromagnetic waves are absorbed, a photoelectric conversion site, an electron-transporting site, a hole-transporting site, an electron-blocking site, a hole-blocking site, a crystallization inhibiting site, electrodes and an interlayer contact improver site.

The organic layer preferably contains an organic p-type compound or an organic n-type compound. Organic p-type semiconductors (compounds) are donor organic semiconductors (compounds) mainly represented by hole-transporting organic compounds, and refers to organic compounds having the property of readily donating electrons. More specifically, organic p-type semiconductors (compounds) refer to the organic compound with the smaller ionization potential when two organic materials are brought into contact with each other in use. Consequently, any organic compound can be used as the donor organic compound provided it is an electron-donating organic compound. Organic n-type semiconductors (compounds) are accepter organic semiconductors (compounds) mainly represented by electron-transporting organic compounds, and refer to organic compounds having the property of readily accepting electrons. More specifically, organic n-type semiconductors (compounds) refer to the organic compound with the greater electron affinity when two organic compounds are brought into contact with each other in use. Consequently, any organic compound can be used as the accepter organic compound provided it is an electron-accepting organic compound.

Detailed descriptions of materials applicable as the organic p-type semiconductor and the organic n-type semiconductor, and of the configuration of the photoelectric conversion layer 72C, are given in JP-A No. 2009-32854, so further description is omitted. The photoelectric conversion layer 72C may also contain fullerenes or carbon nanotubes.

Although it is sufficient for the photoelectric conversion section 72 to include at least the electrodes 72A, 72B, in order to prevent an increase in dark current, it is preferable to provide at least one of an electron blocking layer or a hole blocking layer, and it is more preferable to provide the both.

An electron-blocking layer may be disposed between the lower electrode 72B and the photoelectric conversion layer 72C, and electrons can accordingly be prevented from being injected from the lower electrode 72B into the photoelectric conversion layer 72C when bias voltage is applied between the lower electrode 72B and the upper electrode 72A, thereby preventing an increase in dark current. Electron-donating organic materials can be used for the electron-blocking layer. In practice, the material used for the electron-blocking layer may be selected in accordance with, for example, the material of the adjacent electrode and the material of the adjacent photoelectric conversion layer 72C. A material that has an electron affinity (Ea) greater by 1.3 eV or more than the work function (Wf) of the material of the adjacent electrode and has an ionization potential (Ip) equal to or smaller than the ionization potential of the material of the adjacent photoelectric conversion layer 72C is preferable for the electron-blocking layer. Detailed description of materials applicable as the electron-donating organic material is given in JP-A No. 2009-32854, so further explanation is omitted.

The thickness of the electron-blocking layer is preferably from 10 nm to 200 nm in order to reliably exhibit a dark current reducing effect and to prevent a drop in the photoelectric conversion efficiency of the photoelectric conversion sections 72. The thickness of the electron-blocking layer is more preferably from 30 nm to 150 nm, and particularly preferably from 50 nm to 100 nm.

The hole-blocking layer may be disposed between the photoelectric conversion layer 72C and the upper electrode 72A, so that holes are prevented from being injected from the upper electrode 72A into the photoelectric conversion layer 72C when the bias voltage is applied between the lower electrode 72B and the upper electrode 72A, and thereby preventing an increase in dark current. Electron-accepting organic materials can be used for the hole-blocking layer. In practice, the material used for the hole-blocking layer may be selected in accordance with, for example, the material of the adjacent electrode and the material of the adjacent photoelectric conversion layer 72C. A material that has an ionization potential (Ip) greater by 1.3 eV or more than the work function (Wf) of the material of the adjacent electrode and has an electron affinity (Ea) equal to or greater than the ionization potential of the material of the adjacent photoelectric conversion layer 72C is preferable for the hole-blocking layer. Detailed description of materials applicable as the electron-accepting organic material is given in JP-A No. 2009-32854, so further explanation is omitted.

The thickness of the hole-blocking layer is preferably from 10 nm to 200 nm in order to allow the hole-blocking layer to reliably exhibit a dark current reducing effect and to prevent a drop in the photoelectric conversion efficiency of the photoelectric conversion sections 72. The thickness of the hole-blocking layer is more preferably from 30 nm to 150 nm, and particularly preferably from 50 nm to 100 nm.

The positions of the electron-blocking layer and the hole-blocking layer may be reversed in cases in which the bias voltage is set such that, among the electric charges generated in the photoelectric conversion layer 72C, it is the holes that move to the upper electrode 72A and the electrons that move to the lower electrode 72B. There is no need to provide both of the electron-blocking layer and the hole-blocking layer. A certain degree of a dark current reducing effect can be obtained as long as one or other is provided.

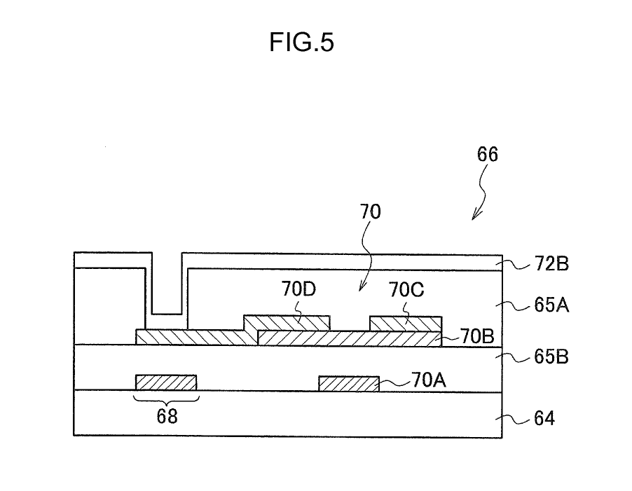

As shown in FIG. 5, the storage capacitors 68 that store the electric charge that has moved to each of the lower electrodes 72B, and the TFTs 70 that output as an electric signal the electric charge stored in each of the storage capacitors 68, are formed on the insulating substrate 64 so as to correspond to the lower electrodes 72B of the photoelectric conversion sections 72. Each of the regions where the storage capacitor 68 and the TFT 70 are formed has a portion that overlaps the lower electrode 72B in a plan view. Due to such a configuration, the storage capacitor 68, the TFT 70 and the photoelectric conversion section 72 overlap along the thickness direction in each of the pixels, which enables the storage capacitor 68, the TFT 70 and the photoelectric conversion section 72 to be disposed over a smaller surface area. Each of the storage capacitors 68 is electrically connected to the corresponding lower electrode 72B via a wiring line of a conductive material that is formed penetrating an insulating film 65A disposed between the insulating substrate 64 and the lower electrode 72B. The electric charges collected by the lower electrode 72B can thereby be moved to the storage capacitor 68.

Each of the TFTs 70 is formed by stacking a gate electrode 70A, a gate insulating film 65B, and an active layer (channel layer) 70B. A source electrode 70C and a drain electrode 70D of the TFT 70 are formed on the active layer 70B at a specific spacing apart from each other. The active layer 70B may be formed from a material such as amorphous silicon, an amorphous oxide material, an organic semiconductor material or carbon nanotubes. However, the material for configuring the active layer 70B is not limited thereto.

Possible amorphous oxide materials for configuring the active layer 70B are for example preferably oxide materials including at least one of In, Ga, and Zn (for example In—O amorphous oxide materials). Oxide materials including at least two of In, Ga, and Zn (for example In—Zn—O amorphous oxide materials, In—Ga—O amorphous oxide materials, or Ga—Zn—O amorphous oxide materials) are more preferred, and oxide materials including all of In, Ga, and Zn are particularly preferred. As such an In—Ga—Zn—O amorphous oxide material, an amorphous oxide material whose composition in a crystalline state would be expressed by InGaO₃(ZnO)ₘ (where m is an integer less than 6) is preferred, and InGaZnO₄ is particularly preferred. However, possible amorphous oxide materials for configuring the active layer 70B are not limited thereto.

Examples of possible organic semiconductor materials for configuring the active layer 70B include, but not limited to, phthalocyanine compounds, pentacene, and vanadyl phthalocyanine derivatives. Detailed description regarding phthalocyanine compounds are given in JP-A No. 2009-212389, so further description thereof is omitted.

If the active layer 70B of each of the TFTs 70 is formed from an amorphous oxide material, an organic semiconductor material, or carbon nanotubes, radiation such as X-rays is not absorbed, or is restricted to extremely minute absorption. The noise superimposed on image signals can accordingly be effectively reduced.

If the active layer 70B is formed with carbon nanotubes, the switching speed of each of the TFTs 70 can be increased and the TFT 70 can be formed with a low degree of absorption of light in the visible light region. In cases of forming the active layer 70B with carbon nanotubes, the performance of the TFT 70 drops significantly even if an extremely minute amount of metal impurity is mixed into the active layer 70B. Therefore, it is necessary to separate, extract, and form extremely high-purity carbon nanotubes by using centrifugal separation, for example.

A layer formed from an organic photoelectric conversion material or a layer formed from an organic semiconductor material both have sufficient flexibility. Accordingly, the radiation detector 60 that sometimes bears the weight of the body of a patient (imaging subject) does not always have to be imparted with high rigidity if a configuration in which a photoelectric conversion layer 72C formed with an organic photoelectric conversion material is combined with a TFT 70 formed from an organic semiconductor material is employed. Consequently, in the radiation detector 60, the active layer of the TFT 70 is preferably formed from an organic semiconductor material.

The insulating substrate 64 may be any substrate with high light transmissivity and low radiation absorption. It is possible to form both amorphous oxide materials forming the active layer 70B of the TFT 70 and organic photoelectric conversion materials forming the photoelectric conversion layer 72C of the photoelectric conversion section 72 into a film at low temperature. Accordingly, the insulating substrate 64 is not limited to substrates with high temperature resistance such as semiconductor substrates, quartz substrates, or glass substrates, and a synthetic resin flexible substrate, aramid or bionanofiber substrate may therefore be employed as the insulating substrate 64. Specifically, flexible substrates of polyesters, for example polyethylene terephthalate, polybutylene phthalate, and polyethylene naphthalate, polystyrene, polycarbonate, polyethersulphone, polyarylate, polyimide, polycyclic olefin, norbornene resin, and poly(chloro-trifluoro-ethylene) or the like may be employed. Employing such a synthetic resin flexible substrate enables a reduction in weight, which is advantageous from such perspectives as portability. Further, other layers may also be provided to the insulating substrate 64, such as an insulating layer to secure insulation, a gas barrier layer to prevent the transmission of one or both of moisture and oxygen, an undercoat layer to improve flatness or adhesion for example to the electrodes, or the like.

Aramids can accommodate high-temperature processing at 200 degrees or higher, enabling a transparent electrode material to be hardened at a high temperature to give a low resistance, and aramids are also compatible with automatic packaging of driver ICs including solder reflow processing. Aramids also have a thermal expansion coefficient that is close to that of indium tin oxide (ITO) and that of a glass substrate, so they show little post manufacture warping and do not readily break. Aramids can also form a thinner substrate than for example a glass substrate. The insulating substrate 64 may be formed by layering an aramid on an ultrathin glass substrate.

Bionanofibers are composites of cellulose microfibril bundles (bacterial cellulose) produced by a bacterium (Acetobacter xylinum) and a transparent resin. Cellulose microfibril bundles have a width of 50 nm, which is a size that is 1/10 visible light wavelengths, and also have high strength, high elasticity, and low thermal expansion. Impregnating bacterial cellulose with a transparent resin such as an acrylic resin or an epoxy resin and curing obtains a bionanofiber that exhibits a light transmittance of about 90% to 500 nm wavelength even while including 60 to 70% of fibers. Since bionanofibers have a low thermal expansion coefficient (3 to 7 ppm) comparable to silicon crystals, a strength comparable to steel (460 MPa), high elasticity (30 GPa), and are flexible, it enables the insulating substrate 64 to be formed thinner than for example a glass substrate.

In a case in which a glass substrate is employed as the insulating substrate 64, the thickness of the radiation detector (TFT substrate) 60 overall will be about 0.7 mm. However, in consideration of making the electronic cassette 32 thinner, the present exemplary embodiment employs a thin substrate formed from a synthetic resin with light transmitting properties as the insulating substrate 64. Thereby, the thickness of the radiation detector (TFT substrate) 60 overall can be made as thin as about 0.1 mm, and the radiation detector (TFT substrate) 60 can also be made flexible. Making the radiation detector (TFT substrate) 60 flexible raises the shock resistance properties of the radiation detector 60 (TFT substrate), and makes the radiation detector (TFT substrate) 60 less susceptible to damage in cases in which shock is imparted to the casing 54 of the electronic cassette 32. Radiation absorption for example by plastic resins and by aramids and bionanofibers is low, and so when the insulating substrate 64 is formed from these materials, due to the amount of radiation absorbed by the insulating substrate 64 being small, a reduction in sensitivity to radiation can be prevented even in cases in which an Irradiation Side Sampling (ISS) method is adopted and radiation passes through the light detection section.

There is no requirement to employ a synthetic resin substrate as the insulating substrate 64 of the electronic cassette 32, and, although the thickness of the electronic cassette 32 increases, a substrate formed from other materials such as glass may be employed as the insulating substrate 64.

As shown in FIG. 6, in the radiation detector (TFT substrate) 60, plural gate lines 76 for switching each of the TFTs 70 ON/OFF are provided extending in a specific direction (row direction), and plural data lines 78 are provided extending in a direction (column direction) intersecting with the specific direction for reading charge stored in the storage capacitors 68 (and between the upper electrodes 72A and the lower electrodes 72B in the photoelectric conversion sections 72) through TFTs 70 that are switched ON. Moreover, as illustrated in FIG. 4, a flattening layer 67 that flattens over the TFT substrate is formed at the side of the radiation detector (TFT substrate) 60 which is opposite to the radiation irradiation side (the radiation-source side).

As illustrated in FIG. 4, in the present exemplary embodiment, the scintillator 71 that absorbs incident radiation and emits light is disposed at the side of the radiation detector 60 opposite to the radiation irradiation side. The flattening layer 67 of the radiation detector 60 is bonded to the scintillator 71 with a bonding layer 69. The wavelength region of the light emitted by the scintillator 71 is preferably in the visible light region (wavelengths of 360 nm to 830 nm). The wavelength region more preferably includes a green wavelength region in order to enable monochrome radiographic image capture by the radiation detector 60. Generally a material such as CsI(Tl) (thallium doped cesium iodide), CsI(Na) (sodium activated cesium iodide), GOS (Gd₂O₂S:Tb) may be employed as a phosphor for application in the scintillator; however, there is no limitation to these materials.

In cases of performing image capture using X-rays as the radiation, it is preferable that the scintillator includes cesium iodide (CsI), and particularly preferable to include CsI(Tl) with an emission spectrum of 420 nm to 700 nm when irradiated with X-rays. The emission peak wavelength in the visible light region of CsI(Tl) is 565 nm. However, while vapor deposition needs to be performed to form the scintillator 71 from CsI, and as explained above, the present exemplary embodiment employs a synthetic resin substrate with low heat resistance as the insulating substrate 64. Therefore, the present exemplary embodiment employs GOS that does not require vapor deposition to be performed for scintillator formation as the scintillator 71. Note that the thickness of the scintillator 71 is made, for example, about 0.3 mm.

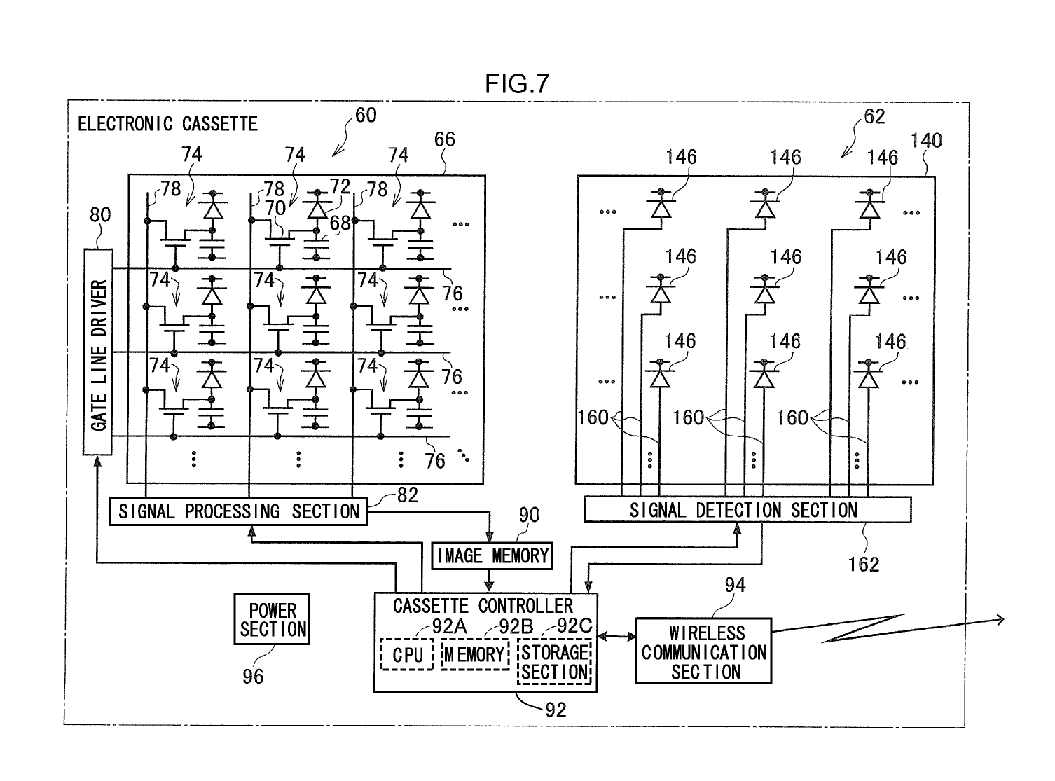

In the present exemplary embodiment, the radiation detection section 62 is provided on the other side of the radiation detector 60, this being the opposite side to that of the scintillator 71 (the radiation-source side). The radiation detection section 62 is configured by sequentially forming a wiring layer 142 patterned with lines 160 (see FIG. 7) and an insulating layer 144, which are described later, on the face of the insulating substrate 64 of the radiation detector 60 on the opposite side to the side formed with the pixels 74. On these layers (at the bottom side in FIG. 4), plural sensor portions 146 for detecting light emitted from the scintillator 71 and transmitted through the radiation detector 60 are formed, and a protection layer 148 is also formed on the sensor portions 146. Note that the thickness of the radiation detection section 62 is for example about 0.05 mm.

The sensor portions 146 are each equipped with an upper electrode 147A and a lower electrode 147B, and with a photoelectric conversion layer 147C disposed between the upper electrode 147A and the lower electrode 147B. The photoelectric conversion layer 147C absorbs light from the scintillator 71 and generates charge. It is possible to apply PIN or MIN photodiodes employing amorphous silicon as the sensor portions 146 (the photoelectric conversion layer 147C). However, in the present exemplary embodiment, similarly to the photoelectric conversion layer 72C of the photoelectric conversion section 72, the photoelectric conversion layer 147C is formed from an organic photoelectric conversion material. Therefore, it is possible to form the photoelectric conversion layer 147C by applying an organic photoelectric conversion material to a base member using a liquid droplet jetting head such as an inkjet head, thereby enabling the insulating substrate 64 to be a thin synthetic resin substrate with light transmitting properties.

The radiation detection section 62 is provided for detecting the timing of radiation irradiation to the electronic cassette 32 and performing detection of cumulative irradiation amounts of radiation onto the electronic cassette 32. The radiation detector 60 is provided for detecting (imaging) radiographic images. Therefore, the sensor portions 146 of the radiation detection section 62 have a larger disposal pitch (have a low placement density) than the pixels 74 of the radiation detector 60, with the light receiving region of a single sensor portion 146 being between several and several hundred times the size of a single pixels 74 of the radiation detector 60.

As illustrated in FIG. 7, the respective gate lines 76 of the radiation detector 60 are connected to a gate line driver 80, and the respective data lines 78 are connected to a signal processing section 82. After radiation that has been transmitted through an imaging subject (radiation that is carrying image data of the imaging subject) is irradiated onto the electronic cassette 32, light is emitted from the scintillator 71 from portions corresponding to each of the positions on the irradiation face 56 at amounts that accord with the irradiation amount of radiation for each position. Charge is generated in the photoelectric conversion section 72 of each of the pixels 74 at a magnitude according to the light intensity of light emitted from the corresponding portion of the scintillator 71, and the charge is accumulated in the storage capacitor 68 (and between the upper electrode 72A and the lower electrode 72B of the photoelectric conversion section 72) of the respective pixels 74.

After the charges have been accumulated in the storage capacitor 68 of each of the pixels 74 as described above, the TFTs 70 of the pixels 74 are switched ON in row unit in sequence by signals supplied from the gate line driver 80 through the gate lines 76. The charge accumulated in the storage capacitor 68 of each of the pixels 74 whose TFT 70 has been switched ON is transmitted by the data line 78 as an analogue electrical signal and input to the signal processing section 82. The charges that have been accumulated in the storage capacitor 68 of the respective pixels 74 are thus read in row unit and in sequence.

The signal processing section 82 is equipped with an amplifier and a sample-and-hold circuit provided for each of the data lines 78, and the electrical signals transmitted by the respective data lines 78 are held in the sample-and-hold circuits after being amplified by the amplifiers. A multiplexer and an analogue-to-digital (A/D) converter are connected in this sequence to the output side of the sample-and-hold circuits. The electrical signals held by the respective sample-and-hold circuits are input in sequence (serially) to the multiplexer, and converted into digital image data by the A/D converter.

An image memory 90 is connected to the signal processing section 82, and the image data output from the A/D converter of the signal processing section 82 is stored in sequence in the image memory 90. The image memory 90 has a storage capacity capable of storing plural frames' worth of image data. The image data obtained by image capture is stored in sequence in the image memory 90 every time radiographic image capture is performed.

The image memory 90 is connected to a cassette controller 92 that controls the overall operation of the electronic cassette 32. The cassette controller 92 includes a microcomputer, a CPU 92A, a memory 92B including ROM and RAM, and a nonvolatile storage section 92C configured for example from a Hard Disk Drive (HDD) or a flash memory.

The cassette controller 92 is connected to a wireless communication section 94. The wireless communication section 94 is compatible with a wireless local area network (LAN) specification such as the Institute of Electrical and Electronics Engineers (IEEE) 802.11a/b/g/n, and controls the transmission of various data between the electronic cassette 32 and an external device via wireless communication. The cassette controller 92 is capable of communication with the console 42 via the wireless communication section 94, and is capable of transmitting and receiving various types of information to and from the console 42.

The same number of lines 160 as the number of the sensor portions 146 are provided in the radiation detection section 62, and the individual sensor portions 146 of the radiation detection section 62 are each connected to a signal detection section 162 through different lines 160 from each other. The signal detection section 162 is equipped with an amplifier, a sample-and-hold circuit and an A/D converter provided for each of the lines 160, and is connected to the cassette controller 92. The cassette controller 92 effects control of the signal detection section 162 to perform sampling of the signals transmitted from the respective sensor portions 146 through the lines 160 at a specific cycle. The signal detection section 162 converts the sampled signals into digital data and outputs the digital data in sequence to the cassette controller 92.

A power section 96 is provided to the electronic cassette 32. The various electrical circuits described above (such as the gate line driver 80, the signal processing section 82, the image memory 90, the wireless communication section 94, the cassette controller 92, and the signal detection section 162) are each connected to the power section 96 (although not illustrated in the drawings for simplification), and operate with power supplied from the power section 96. The power section 96 is installed with the battery (rechargeable battery) 96A mentioned above so as not to affect the portability of the electronic cassette 32, and supplies power to each of the electrical circuits from the charged battery 96A.

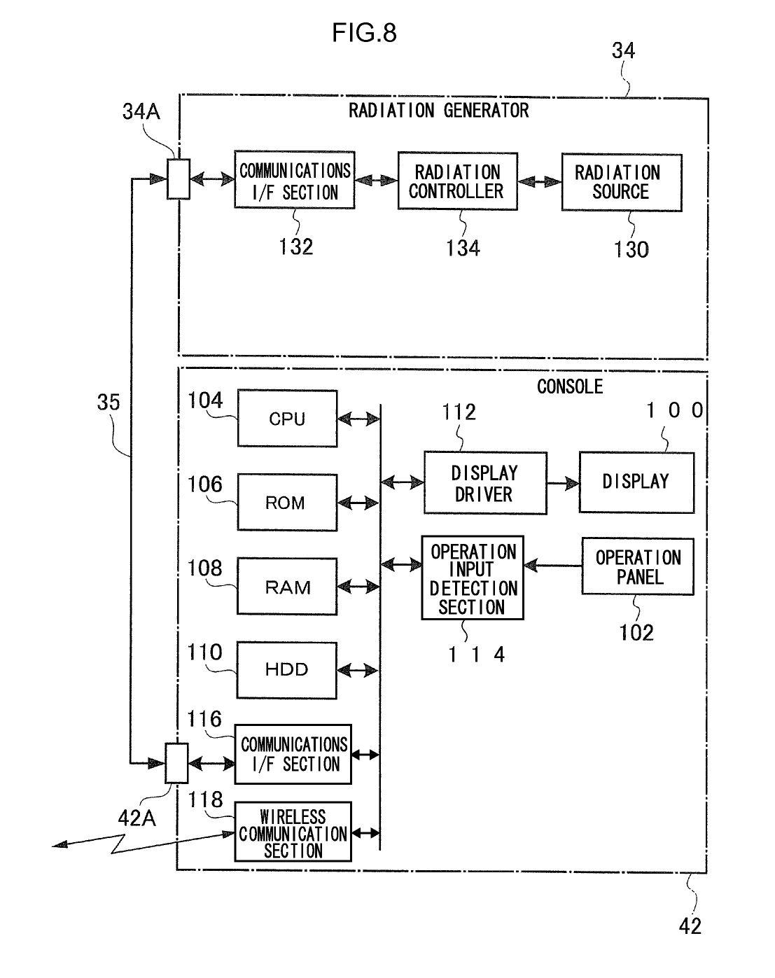

As illustrated in FIG. 8, the console 42 is configured by a computer equipped with a CPU 104 that controls the overall device operation, a ROM 106 pre-installed with various programs including a control program, a RAM 108 that temporarily stores various data, and a HDD 110 that stores various data, and these sections are mutually connected together through a bus. A communications I/F section 116 and a wireless communication section 118 are also connected to the bus, a display 100 is connected through a display driver 112 to the bus, and an operation panel 102 is also connected through an operation input detection section 114 to the bus.

The communications I/F section 116 is connected to the radiation generator 34 through a connection terminal 42A and a communication cable 35. The CPU 104 of the console 42 performs transmission and reception of various data such as exposure conditions with the radiation generator 34 through the communications I/F section 116. The wireless communication section 118 is equipped with functionality for performing wireless communication with the wireless communication section 94 of the electronic cassette 32. The CPU 104 of the console 42 performs transmission and reception of various data such as image data with the electronic cassette 32 through the wireless communication section 118. The display driver 112 generates and outputs a signal for displaying various data on the display 100. The CPU 104 of the console 42 displays for example an operation menu and captured radiographic images on the display 100 through the display driver 112. The operation panel 102 includes plural keys, and is input with various data and operation instructions. The operation input detection section 114 detects operation of the operation panel 102 and gives notifications of the detection results to the CPU 104.

The radiation generator 34 is equipped with the radiation source 130, a communications I/F section 132 that performs transmission and reception of various data such as exposure conditions with the console 42, and a radiation controller 134 that controls the radiation source 130 based on exposure conditions received from the console 42 (the exposure conditions include data such as X-ray tube voltage, X-ray tube current, exposure time period, or any combinations thereof).

Explanation follows regarding operation of the present exemplary embodiment. The electronic cassette 32 according to the present exemplary embodiment is configured such that the scintillator 71, the radiation detector 60 and the radiation detection section 62 are stacked in layers along the radiation incident direction. Accordingly, an increase in size of the electronic cassette 32 along a direction parallel to the irradiation face 56 (i.e., increase in the surface area of the irradiation face 56) due to the addition of the radiation detection section 62 to the electronic cassette 32 can be prevented.

Moreover, in the electronic cassette 32 according to the present exemplary embodiment, the radiation detection section 62 is provided on the other side of the radiation detector 60, which is the opposite side to that of the scintillator 71, and a substrate with light transmitting properties is employed as the insulating substrate 64 of the radiation detector 60, so that the light emitted from the scintillator 71 is transmitted through the radiation detector 60 and incident to the radiation detection section 62. Thus, the light emitted from the scintillator 71 is respectively detected by both the radiation detector 60 and the radiation detection section 62. Therefore, there is no need to separately provide a scintillator for the radiation detector 60 and a scintillator for the radiation detection section 62, which enables reduction of the number of scintillators provided to the electronic cassette 32, that is, only one scintillator is necessary.

Moreover, the electronic cassette 32 according to the present exemplary embodiment employs the insulating substrate 64 of the radiation detector 60 as a support member for supporting the radiation detection section 62, and the radiation detector 60 and the radiation detection section 62 are both provided on the same support member (the insulating substrate 64). Accordingly, there is no need to separately provide a support member for the radiation detection section 62, and the number of support members (substrates or bases) provided to the electronic cassette 32 is reduced.

In the electronic cassette 32 according to the present exemplary embodiment, the photoelectric conversion layer 147C of the radiation detection section 62 is formed from an organic photoelectric conversion material. This enables using a thin substrate made from a synthetic resin with light transmitting properties as the insulating substrate 64, accompanying that the scintillator 71 is formed from GOS, the photoelectric conversion layer 72C of the photoelectric conversion section 72 of the radiation detector 60 is formed from an organic photoelectric conversion material, and the active layer 70B of the TFT 70 is formed from an amorphous oxide material. Further, since the scintillator 71 is formed from a material (such as GOS) not requiring vapor deposition during the formation, there is no need of using a substrate that allows formation of a scintillator by vapor deposition (i.e., a substrate with high heat resistance or vapor deposition substrate).

Thus, the electronic cassette 32 according to the present exemplary embodiment is able to reduce the thickness of the insulating substrate 64 that also functions as the support member for the radiation detection section 62, and there is no need of additional scintillator or additional support member for the radiation detection section 62, even though the radiation detection section 62 has been added. A vapor deposition substrate is also not required for forming the scintillator. Accordingly, the electronic cassette 32 equipped with a function for detecting irradiation of radiation separately from a function of detecting irradiated radiation as an image can be achieved with an extremely thin configuration.

Explanation follows regarding radiographic image capture operation in the radiology information system 10 (the radiographic image capturing systems 18). In a case in which radiographic image capture is performed, the terminal 12 (see FIG. 1) receives an imaging request from a doctor or radiologist. The imaging request specifies a patient as the imaging subject, the image capture site of the imaging subject, the imaging mode (still imaging or video imaging), as well as other specifications such as X-ray tube voltage and X-ray tube current, as needed. The terminal 12 transmits the contents of the received imaging request to the RIS server 14. The RIS server 14 stores the contents of the imaging request transmitted from the terminal 12 in the database 14A. The console 42 acquires the contents of the imaging request and attribute data of the patient to be imaged from the RIS server 14, and displays the contents of the imaging request and the patient attribute data on the display 100 (see FIG. 8).

An operator (radiologist) may perform preparatory work for carrying out radiographic image capture based on the imaging request content displayed on the display 100. For example, in a case in which image capture of an affected region of an imaging subject lying on the lying table 46 (FIG. 2) is to be performed, the electronic cassette 32 is disposed between the lying table 46 and the image capture site of the imaging subject corresponding to the position of the image capture site. The operator may specify the X-ray tube voltage and X-ray tube current for irradiation of radiation X via the operation panel 102.

In the present exemplary embodiment, an automatic irradiation control (called automatic exposure controller (AEC)) is performed to control the irradiation of radiation from the radiation source 130 during radiographic image capture, by detecting the cumulative value of the irradiation amount of radiation to the electronic cassette 32 using the radiation detection section 62. Specifically, the electronic cassette 32 instructs the console 42 to terminate irradiation of radiation from the radiation source 130 if the detected irradiation amount cumulative value of the radiation has reached an upper limit value, and starts reading of an image from the radiation detector 60. If the radiographic image capture is for a still image, the upper limit value for the radiation irradiation amount cumulative value is set at a value that can obtain a clear still image of the image capture site as a radiographic image. If the radiographic image capture is for a video image, the upper limit value for the radiation irradiation amount cumulative value is set as a value that can control the radiation dose to the imaging subject to be within a permissible range.

The upper limit value for the radiation irradiation amount cumulative value may be input through the operation panel 102 by the operator at the time of image capture. Or, respective upper limit values for the radiation irradiation amount cumulative value may be stored in advance for each of the image capture sites, and in response to the specification of the image capture site by the operator through the operation panel 102, the upper limit value for the radiation irradiation amount cumulative value corresponding to the specified image capture site may be read out. Further alternatively, the dosage of separate days for each of the patients may be stored on the database 14A of the RIS server 14, the total dose to the imaging subject over a specific period (for example, the most recent 3 month period) may be computed based on this data, the permissible dose to the imaging subject for current imaging may be computed from the total dose, and the permissible dose may be employed as the upper limit value for the radiation irradiation amount cumulative value.

After the operator has completed the preparatory work, the operator may operate the operation panel 102 to give notification to the console 42 of the completion of the preparatory work. The console uses this operation as a trigger to transmit the specified tube voltage and tube current to the radiation generator 34 as exposure conditions, and to transmit the specified imaging mode (still imaging/video imaging) and the upper limit value of the radiation irradiation amount cumulative value as image capture conditions to the electronic cassette 32. The radiation controller 134 of the radiation generator 34 stores the exposure conditions received from the console 42 in an internal memory, and the cassette controller 92 of the electronic cassette 32 stores the image capture conditions received from the console 42 in the storage section 92C.

After the transmission of the above data to the radiation generator 34 and the electronic cassette 32 has completed normally, the console 42 changes the display on the display 100 to notify the operator that an image capture enabled state has been reached. After confirming this notification, the operator may operate the operation panel 102 to instruct the console 42 to start image capture. Then, the console 42 transmits an instruction signal instructing initiation of exposure to the radiation generator 34. The radiation generator 34 causes radiation to be emitted from the radiation source 130 with the X-ray tube voltage and the X-ray tube current corresponding to the exposure conditions that have been received from the console 42.

Meanwhile, after the image capture conditions have been received from the console 42, the CPU 92A of the cassette controller 92 of the electronic cassette 32 executes an image capture control program that has been installed in advance in the storage section 92C, to perform the image capture control processing illustrated in FIG. 9.

In this image capture control processing, first at step 250, the radiation irradiation amount cumulative value stored in a specific region of the memory 92B is initialized to 0. At next step 252, determination is made as to whether or not the specified imaging mode is a video imaging mode. If the specified imaging mode is the still imaging mode, the determination is negative and processing proceeds to step 256. However, if the specified mode is a video imaging mode, then the determination at step 252 is affirmative and processing proceeds to step 254, at which the image capture cycle according to the frame rate of the video image to be captured is set. Then, the processing proceeds to step 256.

At step 256 a signal level supplied from the gate line driver 80 to the TFTs 70 through the gate lines 76 is switched to a level for switching the TFTs 70 ON at the same time for all of the gate lines 76 of the radiation detector 60, thereby switching ON all of the TFTs 70 in the radiation detector 60. The charges accumulated in the respective storage capacitors 68 of the respective pixels 74 of the radiation detector 60 (and between the upper electrode 72A and the lower electrode 72B of the photoelectric conversion section 72) are thereby discharged, and dark current output from the photoelectric conversion section 72 of the respective pixels 74 is prevented from being accumulated as charge in the period until radiation is irradiated onto the electronic cassette 32.

At the next step 258, the respective output signals transmitted from each of the sensor portions 146 of the radiation detection section 62 through the lines 160 are acquired as digital data (radiation irradiation amount detection values) through the signal detection section 162. The level of the output signal from each of the sensor portions 146 of the radiation detection section 62 varies according to the received amount of light that has been emitted from the scintillator 71, transmitted though the radiation detector (TFT substrate) 60 and received by each of the sensor portions 146. The received light intensity of each of the sensor portions 146 varies according to the light intensity of light emitted from the scintillator 71, and the light intensity of light emitted from the scintillator 71 varies according to the irradiation amount of radiation to the electronic cassette 32. Hence, the value of the digital data correspond to the irradiation amount detection values detected by the radiation detection section 62, represents a detection value of radiation applied to the electronic cassette 32.

At step 260, determination is made as to whether or not the radiation irradiation amount detection values are equal to or greater than a threshold value, based on the radiation irradiation amount detection values acquired from each of the sensor portions 146 of the radiation detection section 62, in order to determine whether or not irradiation of radiation to the electronic cassette 32 has started. The average value of the radiation irradiation amount detection values acquired from each of the sensor portions 146 may be employed as the radiation irradiation amount detection value to be compared with the threshold value. However, since the irradiation amount of the portion of the irradiation face 56 of the electronic cassette 32, which is irradiated with radiation that has been transmitted through the body of the imaging subject is reduced due to the body of the imaging subject absorbing a portion of the radiation, it is preferable to employ the irradiation amount detection values acquired from the sensor portions 146 that correspond to a portion directly irradiated with radiation from the radiation source 130 (i.e., a portion irradiated with radiation that has not been transmitted through the body of the imaging subject).

In this exemplary embodiment, for example, the sensor portion 146 disposed at a position in the vicinity of one of the four corners of the irradiation face 56, where is rarely irradiated with radiation that has been transmitted through the body of the imaging subject may be employed as the sensor portion 146 for obtaining the irradiation amount detection value. Alternatively, since the range on the irradiation face 56 where the radiation from the radiation source 130 is directly irradiated differs according to the image capture site, data of the image capture site may be acquired from the console 42 and the sensor portions 146 employed for obtaining the irradiation amount detection values may be selected according to the image capture site represented by the acquired data.

Processing returns to step 258 if negative determination is made at step 260, and the processing of steps 258 and 260 is repeated until affirmative determination is made at step 260. After irradiation of radiation from the radiation source 130 starts and a portion of the emitted radiation is irradiated onto the electronic cassette 32 after being transmitted through the body of the imaging subject, if the radiation irradiation amount detection value acquired at step 258 is equal to or greater than the threshold value, the determination at step 260 is affirmative and processing transitions to step 262. At step 262, the signal level supplied to the TFTs 70 from the gate line driver 80 through the gate lines 76 is switched to a level to switch OFF the TFTs 70, at the same time for all the gate lines 76 of the radiation detector 60, thereby switching OFF all of the TFTs 70 of the radiation detector 60. Charge accumulation is thereby started in the storage capacitors 68 (and between the upper electrode 72A and the lower electrode 72B of the photoelectric conversion section 72) of the respective pixels 74 in the radiation detector 60.

At the next step 264, determination is made as to whether or not the specified imaging mode is a video imaging mode. If the specified imaging mode is a still imaging mode, the determination is negative and processing transitions to step 266 where the radiation irradiation amount detection values from each of the sensor portions 146 of the radiation detection section 62 are acquired. At step 268, determination is made as to whether or not the radiation irradiation amount detection values acquired from each of the sensor portions 146 are 0 or close to 0. This determination is determination as to whether or not radiation irradiation from the radiation source 130 has terminated, and if negative determination is made, processing transitions to step 270, and the radiation irradiation amount detection value acquired at step 266 (for example, the average value of the radiation irradiation amount acquired from each of the sensor portions 146) is added to the radiation irradiation amount cumulative value. At the next step 272, determination is made as to whether or not the radiation irradiation amount cumulative value is equal to or greater than the upper limit value received from the console 42. If this determination is negative, processing returns to step 266 and the processing of step 266 to step 272 is repeated until determination at step 268 or step 272 is affirmative.

In the still imaging mode, if an exposure end timing arrives, the console 42 instructs the radiation generator 34 to terminate irradiation of radiation, and the radiation generator 34 terminates radiation irradiation from the radiation source 130. In this case, termination of radiation irradiation to the electronic cassette 32 leads to affirmative determination at step 268, processing transitions to step 276 and charges that have accumulated in the storage capacitors 68 (and between the upper electrode 72A and the lower electrode 72B of the photoelectric conversion section 72) of the respective pixels 74 are read out in sequence as signals of a captured radiographic image by switching ON the TFTs 70 of the radiation detector 60 in sequence of units of the gate lines 76. Then at step 278 the data of the radiographic images obtained by read-out of charge at step 276 is transmitted to the console 42 by wireless communication, and the image capture control processing is completed.

However, if the radiation irradiation amount cumulative value reaches the upper limit value prior to the exposure end timing, the determination of step 272 becomes affirmative prior to the determination at step 268 being affirmative, processing transitions to step 274, and a signal instructing termination of exposure is transmitted to the console 42 by wireless communication. The console 42 accordingly instructs the radiation generator 34 to terminate radiation irradiation and the radiation generator 34 terminates radiation irradiation from the radiation source 130. Capture of a still image is thereby terminated. Then at step 276, charge are read out from each of the pixels 74 of the radiation detector 60, at step 278, radiographic image data is transmitted to the console 42, and then the image capture control processing is completed.

If the imaging mode is a video imaging mode, determination at step 264 is affirmative and processing transitions to step 280. Similarly to the previously described step 266 to step 272, the radiation irradiation amount detection value(s) from each of the sensor portions 146 of the radiation detection section 62 are acquired (step 280), determination is made as to whether or not the acquired radiation irradiation amount detection value is 0 or close to 0 (step 282), if this determination is negative, the acquired radiation irradiation amount detection value is added to the radiation irradiation amount cumulative value (step 284), and determination is made as to whether or not the radiation irradiation amount cumulative value is equal to or greater than the upper limit value received from the console 42 (step 286).

If negative determination has been made at step 286, processing transitions to step 288 and determination is made as to whether or not a timing for reading out charge from each of the pixels 74 of the radiation detector 60 has arrived based on determination as to whether or not the elapsed time from starting image capture (after charge has already been read from each of the pixels 74 of the radiation detector 60, this is the elapsed time from the previous time of reading out charge) is equal to a period of time equivalent to the image capture cycle that has been set at step 254. If this determination is negative, processing returns to step 280 and the processing of step 280 to step 288 is repeated until affirmative determination is made at step 282, step 286 or step 288. If the timing for reading out charge has arrived, determination at step 288 is affirmative and processing transitions to step 290, and charge is read out from each of the pixels 74 of the radiation detector 60 similarly to in the step 276 described above. Then at step 292, radiographic image data is transmitted to the console 42 and processing returns to step 280.

In the video imaging mode, the operator instructs termination of image capture (termination of exposure) through the operation panel 102 The console 42 accordingly instructs the radiation generator 34 to terminate radiation irradiation and the radiation generator 34 terminates radiation irradiation from the radiation source 130. In this case, determination at step 282 becomes affirmative due to the termination of irradiation of radiation to the electronic cassette 32, and the image capture control processing is completed.

If the radiation irradiation amount cumulative value reaches the upper limit value or greater prior to the instruction of termination of image capture (termination of exposure) by the operator, affirmative determination is made at step 286 prior to affirmative determination at step 282, processing transitions to step 274, a signal instructing termination of exposure is transmitted to the console 42 by wireless communication, and the image capture control processing is completed. The console 42 thereby instructs the radiation generator 34 to terminate radiation irradiation, and video image capture is aborted as a result of the radiation generator 34 terminating radiation irradiation from the radiation source 130.

Explanation has been hitherto given of an embodiment in which video image capture is aborted if the radiation irradiation amount cumulative value has reached the upper limit value or greater in the video imaging mode. However, embodiments are not limited thereto, and notification may be given to the console 42 that the radiation irradiation amount cumulative value has reached the upper limit value or greater, and the console 42 may perform display processing of a warning on the display 100. Alternatively, the console 42 may instruct the radiation generator 34 to change the exposure conditions to reduce at least one of the X-ray tube voltage or the X-ray tube current, such that the radiation amount per unit time irradiated from the radiation source 130 is reduced.

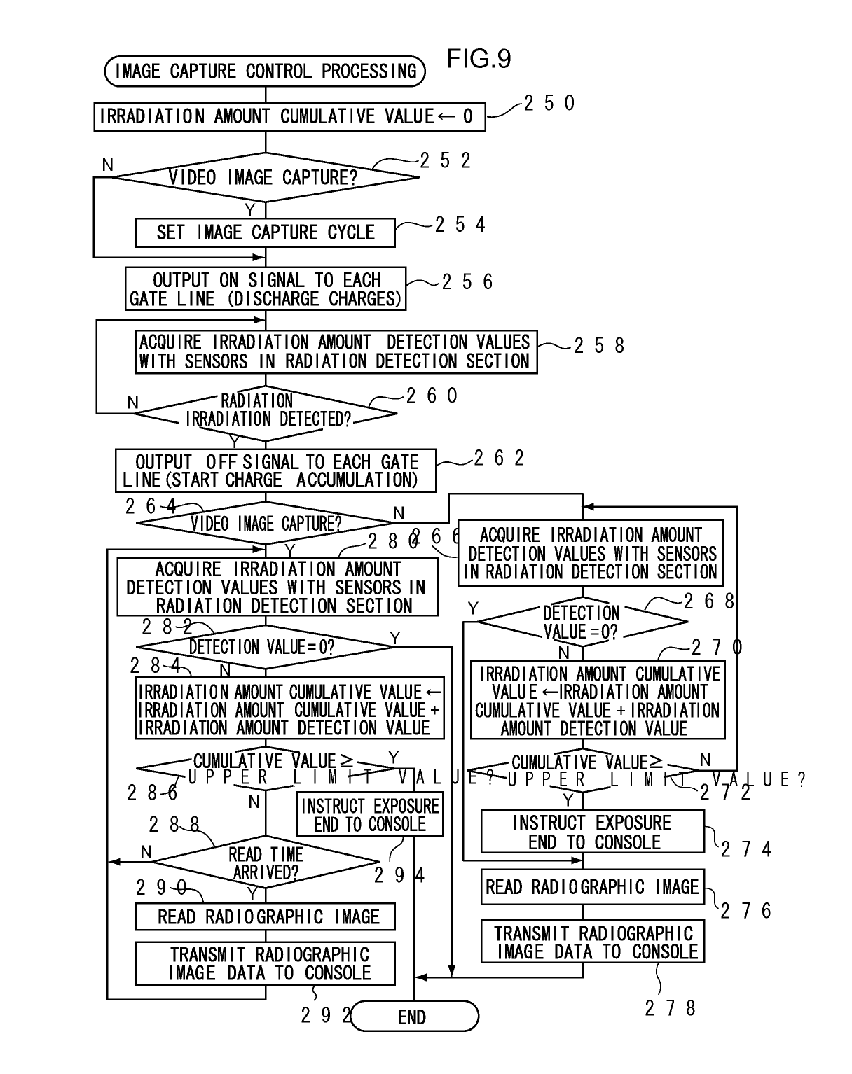

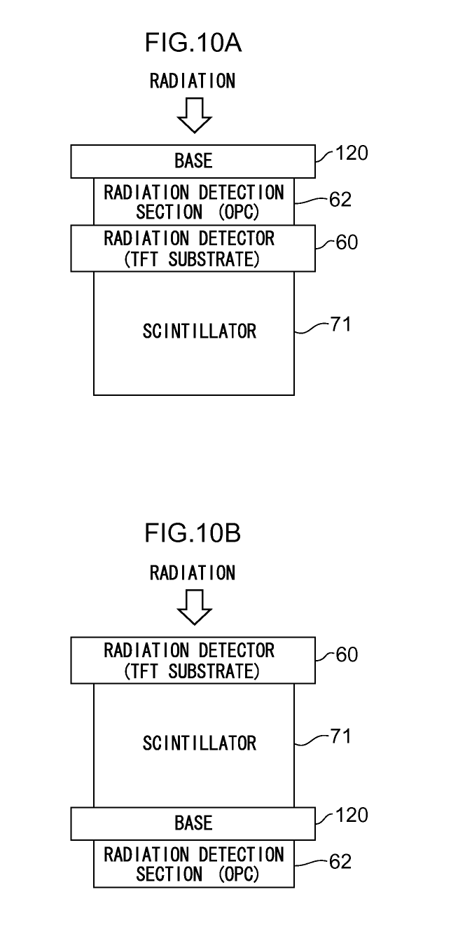

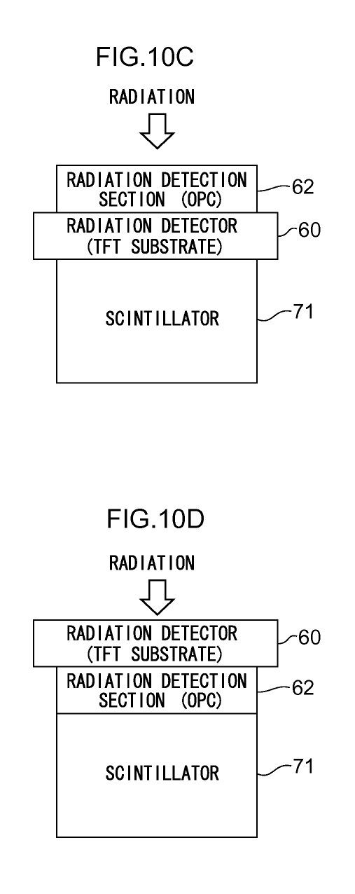

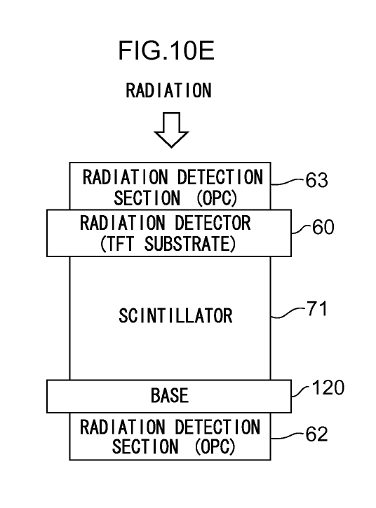

Explanation follows regarding another configuration of the radiation detection panel according to the present invention. As schematically illustrated in FIG. 10C, the electronic cassette 32 explained above includes the scintillator 71 formed from a material not requiring vapor deposition (for example GOS) disposed on one face of the radiation detector 60, and the radiation detection section 62 provided on the other face of the radiation detector 60, and is irradiated with radiation on the radiation detection section 62 side. The radiation detector 60 (first detection section) detects light emitted from the scintillator 71 (light emitting section) as an image, and the radiation detection section 62 (second detection section) also detects light emitted from the scintillator 71 (light emitting section).

In this configuration, the radiation detector 60 is disposed on the radiation irradiation face side of the scintillator 71, and a method with a light emitting section (scintillator) and a light detection section (radiation detector) disposed with such a positional relationship is called “Irradiation Side Sampling (ISS)”. Since the scintillator has a higher intensity of light emission on the radiation incident side, “Irradiation Side Sampling (ISS)”, wherein the light detection section (radiation detector) is disposed at the radiation incident side of the scintillator, has the light detection section and the light emission position of the scintillator disposed in closer positioning than in a case in which the light detection section (radiation detector) is disposed at the opposite side of the radiation irradiation face of the light emitting section (scintillator) in “Penetration Side Sampling (PSS)”. Therefore, the resolution of the radiographic images obtained by image capture is higher in ISS method, and the amount of light received by the light detection section (radiation detector) is increased, and as a result the sensitivity of the radiation detection panel (electronic cassette) is raised.

Examples for configurations for a radiation detection panel employing a scintillator formed from a material requiring no vapor deposition with an “Irradiation Side Sampling” positional relationship between the scintillator 71 and the radiation detector 60, other than the configuration of FIG. 10C, include the configurations illustrated in FIG. 10A, FIG. 10B, FIG. 10D and FIG. 10E.

The configuration illustrated in FIG. 10A has a same positional relationship between the scintillator 71, the radiation detector 60 and the radiation detection section 62 as that of the configuration illustrated in FIG. 10C. However, it differs from the configuration illustrated in FIG. 10C in the point that after the radiation detection section 62 is formed on a base 120 as the support member, the radiation detection section 62 is adhered to the side of the radiation detector 60 on the opposite side of the scintillator 71. In such a configuration, the thickness is greater than that of the configuration illustrated in FIG. 10C by the thickness of the base 120. However, since a flexible substrate made from a synthetic resin (for example polyethylene terephthalate) as described above is applicable as the base 120, it is possible to reduce the thickness of the base 120 itself, for example, to about 0.1 mm. In the configuration illustrated in FIG. 10A, a reflective layer may be provided between the radiation detector 60 and the radiation detection section 62 to partially reflect the light emitted from the scintillator 71 and transmitted through the radiation detector (TFT substrate) 60.

In the configuration illustrated in FIG. 10B, the radiation detector 60 is disposed on one face of the scintillator 71, and the back face (the opposite face to the face on which the radiation detection section 62 is formed) of a base 120 formed with the radiation detection section 62 is adhered to the other face of the scintillator 71. In this configuration, “Penetration Side Sampling” method is adopted due to the positional relationship between the scintillator 71 and the radiation detection section 62, in which although the amount of light received by the radiation detection section 62 is reduced. However, since the radiation detection section 62 is employed for detecting the radiation irradiation timing and the irradiation amount of radiation, it is possible to employ a configuration in which, for example, the placement pitch of the sensor portions 146 is increased and the surface area of the light receiving region of each of the sensor portions 146 is increased (for example to 1 cm×1 cm or greater). This configuration enables compensation for any reduction in sensitivity accompanying the reduction in amount of light received at the radiation detection section 62.

In the configuration illustrated in FIG. 10D, the radiation detection section 62 is formed on one face of the radiation detector 60, and the scintillator 71 is adhered to the other face of the radiation detection section 62, on the opposite side to that of the radiation detector 60. In this configuration, the thickness can be reduced as well as the configuration illustrated in FIG. 10C. However, since the radiation detection section 62 is disposed between the scintillator 71 and the radiation detector 60, a portion of the light emitted from the scintillator 71 is absorbed by the radiation detection section 62, and the amount of light received by the radiation detector 60 is reduced.

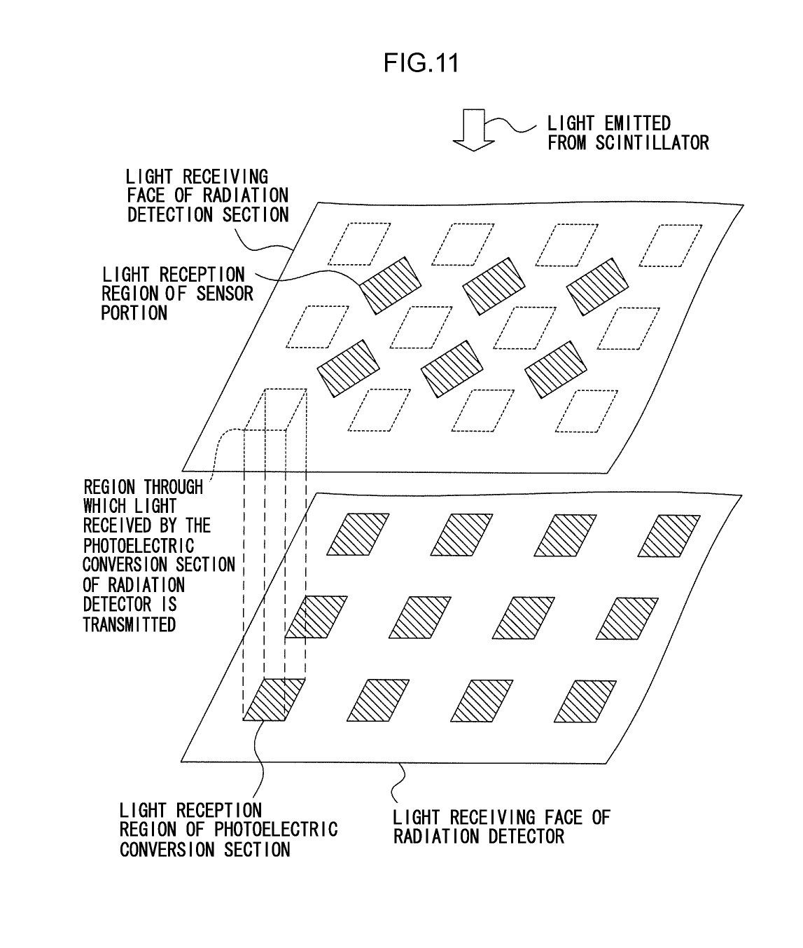

Therefore, as illustrated in the example of FIG. 11, the light reception regions of the sensor portions 146 of the radiation detection section 62 may be respectively disposed in a range that does not block the light emitted from the scintillator 71 and incident to the photoelectric conversion section 72 of each of the pixels 74 of the radiation detector 60 (i.e., in a region outside of the regions transmitting light that is incident to the photoelectric conversion section 72). Any reduction in sensitivity of the radiation detection panel accompanying a reduction in the amount of light received by the radiation detector 60 can thereby be prevented. The placement of the light reception regions of the sensor portions 146 as illustrated in FIG. 11 corresponds to an example of the sixth aspect of the present invention.

In the configuration illustrated in FIG. 10E, in contrast to the configuration illustrated in FIG. 10B, a radiation detection section 63 that is similar to the radiation detection section 62 is disposed on the other side of the radiation detector 60, which is opposite to the side of the scintillator 71. In such a configuration, the thickness is increased compared to the configuration illustrated in FIG. 10B by the thickness of the radiation detection section 63. However, the thickness of the radiation detection section 63 can be formed to, for example, about 0.05 mm, similarly to the radiation detection section 62. The two individual radiation detection sections 62, 63 may be utilized in this configuration for the purpose of improving the overall sensitivity of the radiation detection section(s) by, for example, adding together each of the radiation irradiation amount detection values. The two radiation detection sections 62, 63 may also be utilized such that one of the radiation detection sections is employed for detecting the irradiation timing of radiation to the electronic cassette 32, and the other of the radiation detection sections is employed for detecting the irradiation amount of radiation to the electronic cassette 32. In such cases, it is possible to optimize the characteristics of the radiation detection sections 62, 63 to their respective roles. For example, the radiation detection section employed for detecting the radiation irradiation timing may have adjusted electrostatic capacitance and line resistance to raise response speed, and the radiation detection section employed for detecting the irradiation amount of radiation may have adjusted surface area of the light reception regions so as to raise sensitivity.

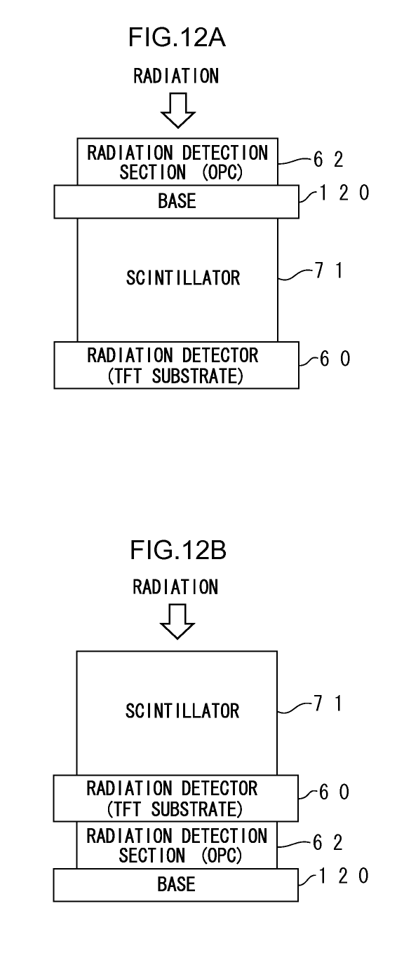

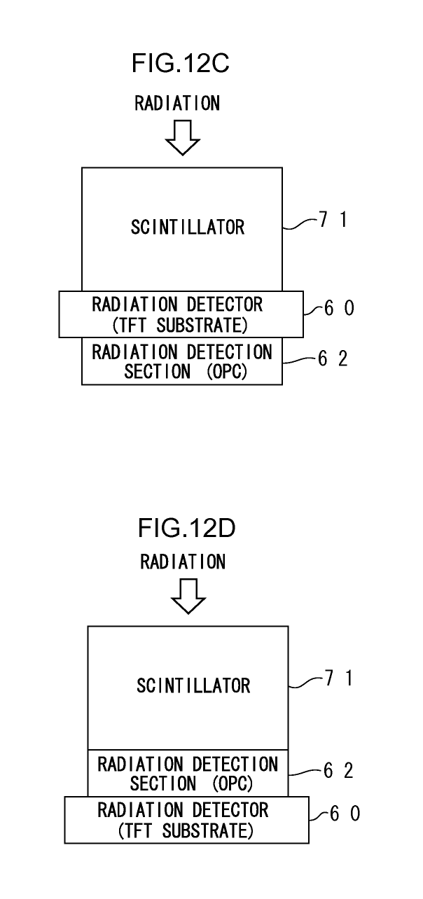

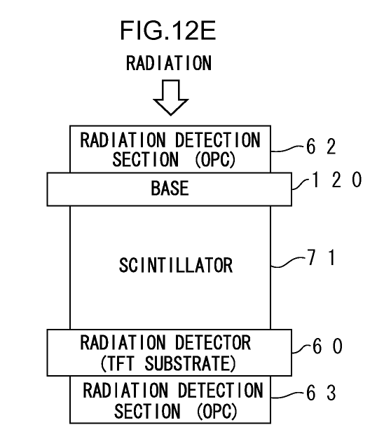

Examples for configurations for a radiation detection panel employing a scintillator configured by a material not requiring vapor deposition with a “Penetration Side Sampling” positional relationship between the scintillator 71 and the radiation detector 60, include the configurations illustrated in FIG. 12A to FIG. 12E.

The configuration illustrated in FIG. 12A is the same as the configuration illustrated in FIG. 10B; however, the radiation arrives from the opposite direction to that in the configuration illustrated in FIG. 10B. In this configuration, the radiation detection section 62 is positioned at the most radiation-source side. However, since radiation absorption does not occur in the radiation detection section 62, no reduction occurs in the irradiation amount of radiation to the scintillator 71 even though the radiation detection section 62 is disposed in the position described above. In the configuration illustrated in FIG. 12A, a reflective layer may be provided between the scintillator 71 and the radiation detection section 62 to partially reflect light emitted from the scintillator 71 and incident to the radiation detection section 62. As described above, in a case in which the positional relationship between the scintillator 71 and the radiation detection section 62 realizes “Penetration Side Sampling” method, the amount of light received by the radiation detector 60 is reduced compared to “Irradiation Side Sampling” method. However, reduction in the amount of light received by the radiation detector 60 can be compensated for by providing the reflective layer as described above.

The configuration illustrated in FIG. 12B is the same as the configuration illustrated in FIG. 10A; however, radiation arrives from the opposite direction to that of the configuration illustrated in FIG. 10A. In this configuration, since the positional relationship between the scintillator 71 and the radiation detection section 62 realizes “Penetration Side Sampling” method and, further, light that has been transmitted through the radiation detector 60 is incident to the radiation detection section 62, the amount of light received by the radiation detection section 62 is reduced. However, since the radiation detection section 62 is employed for detecting the irradiation timing and irradiation amount of radiation, and it is possible to adopt a configuration in which, for example, the placement pitch of the sensor portions 146 is increased and the surface area of the light receiving region of each of the sensor portions 146 is increased (for example to 1 cm×1 cm or greater). This configuration enables compensation for reduction in sensitivity accompanying the reduction in the amount of light received by the radiation detection section 62.

The configuration illustrated in FIG. 12C is the same as the configuration illustrated in FIG. 10C; however, radiation arrives from the opposite direction to that of the configuration illustrated in FIG. 10C. Also in this configuration, as in the configuration illustrated in FIG. 12B, the positional relationship between the scintillator 71 and the radiation detection section 62 realizes “Penetration Side Sampling” method, and light that has been transmitted through the radiation detector 60 is incident to the radiation detection section 62, which results in a reduction in the amount of light received by the radiation detection section 62. However, it is possible to compensate for reduction in sensitivity accompanying the reduction in amount of light received by increasing the placement pitch of the sensor portions 146 and increasing the surface area of the light receiving region of each of the sensor portions 146 (for example to 1 cm×1 cm or greater). This configuration achieves the thinnest thickness among the configurations illustrated in FIG. 12A to 12E, and is preferable in that there is no limitation to the placement of the sensor portions 146 of the radiation detection section 62 such as in the configuration illustrated in FIG. 12D, which is described next.

The configuration illustrated in FIG. 12D is the same as the configuration illustrated in FIG. 10D; however, radiation arrives from the opposite direction to that of the configuration illustrated in FIG. 10D. Also in this configuration the radiation detection section 62 is disposed between the scintillator 71 and the radiation detector 60, and the amount of light received by the radiation detector 60 is reduced due to a portion of the light emitted from the scintillator 71 being absorbed by the radiation detection section 62. Therefore, similarly to the configuration illustrated in FIG. 10D, the light reception region of each of the sensor portions 146 of the radiation detection section 62 is disposed in a range that does not block light emitted from the scintillator 71 and is incident to the photoelectric conversion section 72 of each of the pixels 74 of the radiation detector 60 (see FIG. 11). Thereby, reduction in sensitivity of the radiation detection panel accompanying the reduction in the amount of light received by the radiation detector 60 can be prevented.

The configuration illustrated in FIG. 12E is the same as the configuration illustrated in FIG. 10E; however, radiation arrives from the opposite direction to that of the configuration illustrated in FIG. 10E. Also in this configuration, the two individual radiation detection sections 62, 63 may be utilized for the purpose of raising the overall sensitivity of the radiation detection sections by, for example, adding together each of the radiation irradiation amount detection values, as well as the configuration illustrated in FIG. 10E. Alternatively, the two radiation detection sections 62, 63 may be employed such that one of the radiation detection sections is employed for detecting the irradiation timing of radiation to the electronic cassette 32, and the other of the radiation detection sections is employed for detecting the irradiation amount of radiation to the electronic cassette 32.

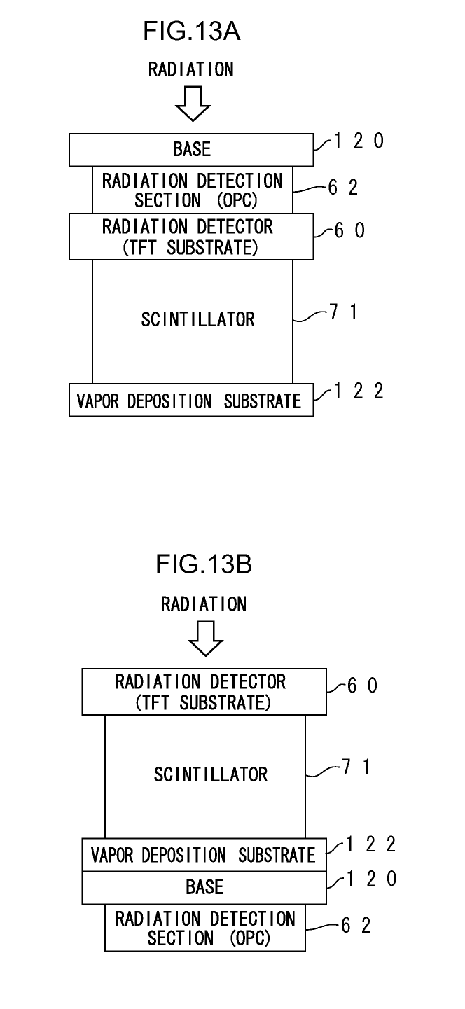

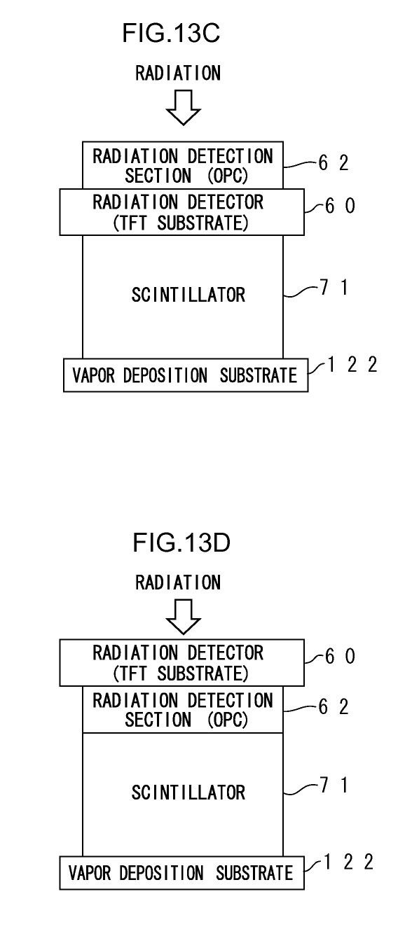

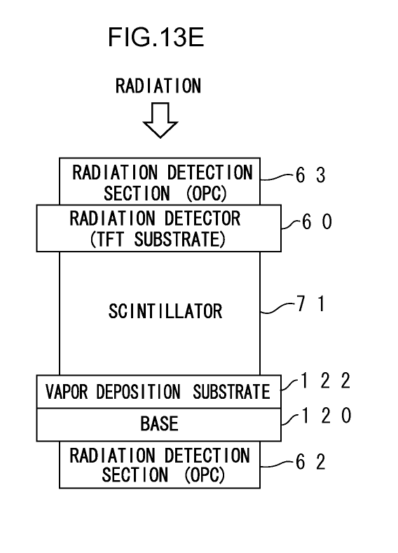

Examples for configurations for a radiation detection panel employing a scintillator formed by evaporating a material such as CsI on a vapor deposition substrate 122 (see FIG. 13A to FIG. 13E) and having positional relationship between the scintillator 71 and the radiation detector 60, which realizes “Irradiation Side Sampling” method, include the configurations illustrated in FIG. 13A to FIG. 13E.

The configuration illustrated in FIG. 13A differs from that of FIG. 10A in the point that the vapor deposition substrate 122 is disposed on the other side of the scintillator 71, which is the opposite side of the radiation detector 60. In the configuration illustrated in FIG. 13A, a reflective layer may also be provided between the radiation detector 60 and the radiation detection section 62 to partially reflect the light emitted by the scintillator 71 and has been transmitted through the radiation detector (TFT substrate) 60.

The configuration illustrated in FIG. 13B differs from that of FIG. 10B in the point that the vapor deposition substrate 122 is disposed between the scintillator 71 and the base 120. In this configuration, the light emitted from the scintillator 71 is incident to the radiation detection section 62 after being transmitted through the vapor deposition substrate 122 and the base 120. Therefore, it is necessary to employ a substrate with light transmitting properties such as a glass substrate for the vapor deposition substrate 122, in place of substrates made from, for example, aluminum (Al), which are widely employed as vapor deposition substrates from the perspectives of radiation transmissivity and cost.

The configuration illustrated in FIG. 13C differs from that of FIG. 10C in the point that the vapor deposition substrate 122 is disposed on the other side of the scintillator 71, which is the opposite side of the radiation detector 60. This configuration achieves the thinnest thickness among the configurations illustrated in FIG. 13A to FIG. 13E, and is preferable in that there is no limitation to the placement of the sensor portions 146 of the radiation detection section 62, such as in the configuration illustrated in FIG. 13D, which is described next.

The configuration illustrated in FIG. 13D differs from that of FIG. 10D in the point that the vapor deposition substrate 122 is disposed on the other side of the scintillator 71, which is the opposite side of the radiation detection section 62. In this configuration, since the radiation detection section 62 is disposed between the scintillator 71 and the radiation detector 60, the amount of light received by the radiation detector 60 is reduced due to a portion of the light emitted from the scintillator 71 being absorbed by the radiation detection section 62. Accordingly, similarly to the configurations illustrated in FIG. 10D and FIG. 12D, the light reception region of each of the sensor portions 146 of the radiation detection section 62 may be disposed in a range that does not block the light emitted from the scintillator 71 that is incident to the photoelectric conversion section 72 of each of the pixels 74 of the radiation detector 60 (see FIG. 11). Thereby, reduction in sensitivity of the radiation detection panel accompanying the reduction in the amount of light received by the radiation detector 60 can be prevented.

The configuration illustrated in FIG. 13E differs from that of FIG. 10E in the point that the vapor deposition substrate 122 is disposed between the scintillator 71 and the base 120. In this configuration, similarly to the configuration illustrated in FIG. 13B, the light emitted from the scintillator 71 is incident to the radiation detection section 62 after being transmitted through the vapor deposition substrate 122 and the base 120. Therefore, a substrate with light transmitting properties such as a glass substrate is required for the vapor deposition substrate 122. In this configuration, similarly to the configurations illustrated in FIG. 10E and FIG. 12E, the two radiation detection sections 62, 63 may be utilized for the purpose of raising the overall sensitivity of the radiation detection sections, or one of the radiation detection sections may be employed for detecting the irradiation timing of radiation to the electronic cassette 32, and the other of the radiation detection sections may be employed for detecting the irradiation amount of radiation to the electronic cassette 32.

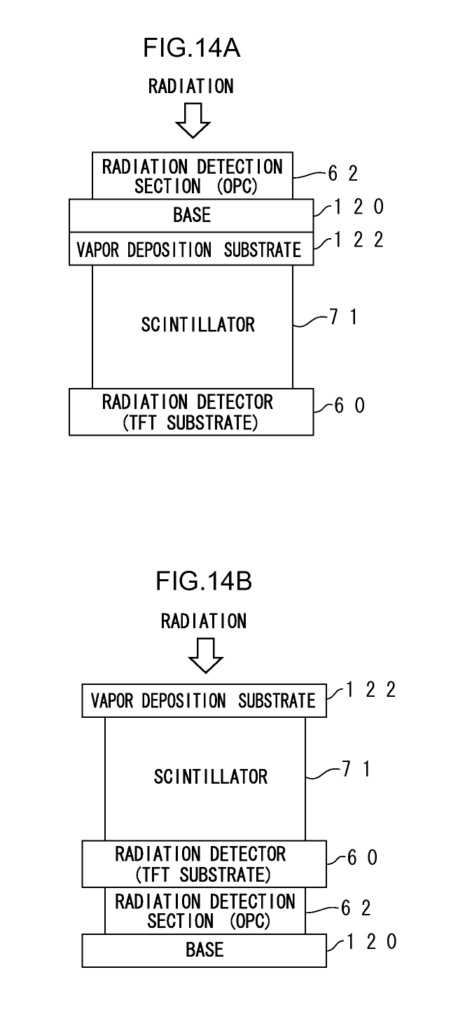

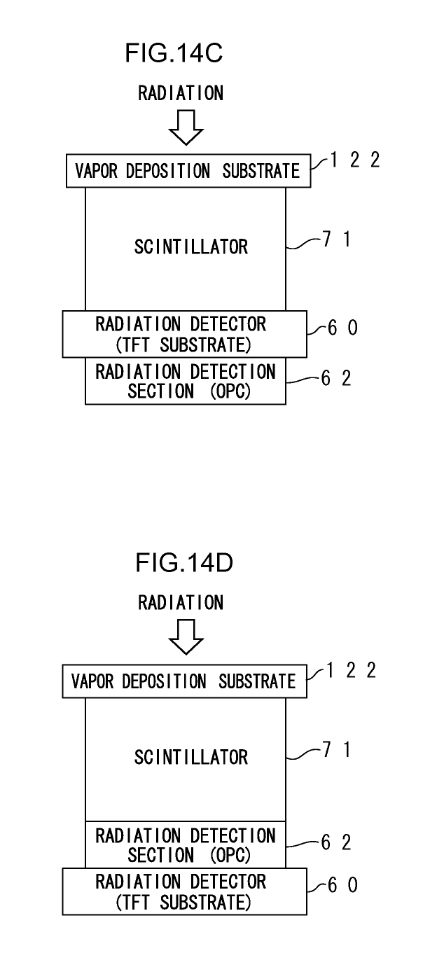

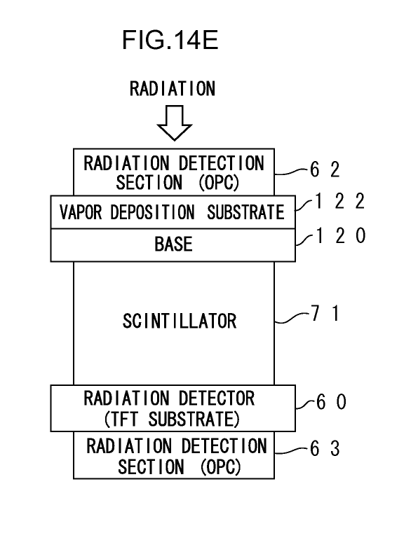

Examples for configurations for a radiation detection panel employing a scintillator formed by evaporating a material such as CsI on a vapor deposition substrate 122 and having positional relationship between the scintillator 71 and the radiation detector 60, which realizes a “Penetration Side Sampling” method, include the configurations illustrated in FIG. 14A to FIG. 14E.

The configuration illustrated in FIG. 14A is the same as the configuration illustrated in FIG. 13B; however, radiation arrives from the opposite direction to that of the configuration illustrated in FIG. 13B. In this configuration, the light emitted from the scintillator 71 is incident to the radiation detection section 62 after being transmitted through the vapor deposition substrate 122 and the base 120. Therefore, a substrate with light transmitting properties, such as a glass substrate, is required as the vapor deposition substrate 122.

The configuration illustrated in FIG. 14B is the same as the configuration illustrated in FIG. 13A; however, radiation arrives from the opposite direction to that of the configuration illustrated in FIG. 13A. In this configuration, the positional relationship between the scintillator 71 and the radiation detection section 62 realizes “Penetration Side Sampling” method and the amount of light received by the radiation detection section 62 is reduced due to light that has been transmitted through the radiation detector 60 being incident to the radiation detection section 62. However, it is possible to compensate for reduction in sensitivity accompanying the reduction in the amount of light received by the radiation detection section 62 by, for example, increasing the placement pitch of the sensor portions 146 of the radiation detection section 62 and increasing the surface area of the light receiving region of each of the sensor portions 146 (for example to 1 cm×1 cm or greater).

The configuration illustrated in FIG. 14C is the same as the configuration illustrated in FIG. 13C; however, radiation arrives from the opposite direction to that of the configuration illustrated in FIG. 13C. Similarly to the configuration illustrated in FIG. 14B, in this configuration, the positional relationship between the scintillator 71 and the radiation detection section 62 realizes “Penetration Side Sampling” method and the amount of light received by the radiation detection section 62 is reduced due to light that has been transmitted through the radiation detector 60 being incident to the radiation detection section 62. However, it is possible to compensate for reduction in sensitivity accompanying the reduction in the amount of light received by the radiation detection section 62 by, for example, increasing the placement pitch of the sensor portions 146 of the radiation detection section 62 and increasing the surface area of the light receiving region of each of the sensor portions 146 (for example to lcm x lcm or greater). This configuration achieves the thinnest thickness among the configurations illustrated in FIG. 14A to 14E, and is preferable in that there is no limitation to the placement of the sensor portions 146 of the radiation detection section 62 such as in the configuration illustrated in FIG. 14D, which is described next.

The configuration illustrated in FIG. 14D is the same as the configuration illustrated in FIG. 13D; however, radiation arrives from the opposite direction to that of the configuration illustrated in FIG. 13D. In this configuration, due to the radiation detection section 62 being disposed between the scintillator 71 and the radiation detector 60, the amount of light received by the radiation detector 60 is reduced due to a portion of the light emitted from the scintillator 71 being absorbed by the radiation detection section 62. Accordingly, similarly to the configurations illustrated in FIG. 10D, FIG. 12D and FIG. 13D, the light reception region of each of the sensor portions 146 of the radiation detection section 62 may be disposed in a range that does not block the light emitted from the scintillator 71 and is incident to the photoelectric conversion section 72 of each of the pixels 74 of the radiation detector 60 (see FIG. 11). Thereby, reduction in sensitivity of the radiation detection panel accompanying the reduction in the amount of light received by the radiation detector 60 can be prevented.

The configuration illustrated in FIG. 14E is the same as the configuration illustrated in FIG. 13E; however, radiation arrives from the opposite direction to that of the configuration illustrated in FIG. 13E. Similarly to the configuration illustrated in FIG. 13E, this configuration may utilize the two radiation detection sections 62, 63 for the purpose of raising the overall sensitivity of the radiation detection sections by, for example, adding together the respective irradiation amount detection values, or one of the radiation detection sections may be employed for detecting the irradiation timing of radiation to the electronic cassette 32, and the other of the radiation detection sections may be employed for detecting the irradiation amount of radiation to the electronic cassette 32.

The photoelectric conversion section 72 of the radiation detector 60 may be formed by an organic CMOS sensor in which the photoelectric conversion layer is formed from a material containing an organic photoelectric conversion material. The TFT substrate of the radiation detector 60 may be formed by using an organic TFT array-sheet in which organic transistors containing an organic material, which serve as the TFTs 70, are arrayed on a flexible sheet. An example of such an organic CMOS sensor is described in, for example, JP-A No. 2009-212377. An example of such an organic TFT array-sheet is described in, for example, the Nikkei Newspaper article published online (search date Apr. 11, 2011) “Tokyo University develops “Ultra-flexible Organic Transistor””, Internet <URL: http://www.nikkei.com/tech/trend/article/g=96958A9C93819499E2EAE2E0E48DE2EAE3E3 E0E2E3E2E2E2E2E2E2E2; p=9694E0E7E2E6E0E2E3E2E2E0E2E0>”.

Even if the TFTs 70 of the radiation detector 60 do not have light transmitting properties (for example, if the active layer 70B is formed from a material that does not have light transmitting properties such as amorphous silicon), it is possible to obtain a radiation detector 60 with light transmitting properties by disposing the TFTs 70 on an insulating substrate 64 having light transmitting properties (for example, a flexible substrate made with a synthetic resin) such that light may transmit through portions of the insulating substrate 64 where the TFTs 70 and the like are not formed. Disposing the TFTs 70 without light transmitting properties on the insulating substrate 64 having light transmitting properties can be achieved by applying technology for separating micro device blocks manufactured on a first substrate from the first substrate and disposing on a second substrate specifically, by applying technique such as Fluidic Self-Assembly (FSA). The FSA is described, for example, in “Toyama University “Research of Fluidic Self-Assembly of Micro Semiconductor Blocks”, published online (search date Apr. 11, 2011), Internet <URL: http://www3.u-tyama.ac.jp/maezawa/Research/FSA.html>”.

By imparting light transmitting properties to the radiation detector 60 as described above, in a configuration in which the radiation detection section 62 (or the radiation detection section 63) disposed on the other side of the radiation detector 60, which is the opposite side of the scintillator 71, as illustrated for example in FIG. 10A, FIG. 10C, FIG. 10E, FIG. 12B, FIG. 12C, FIG. 12E, FIG. 13A, FIG. 13C, FIG. 13E, FIG. 14B, FIG. 14C and FIG. 14E, it is possible to achieve configurations in which a portion of the light emitted from the scintillator 71 being transmitted through the radiation detector 60 and is incident on the radiation detection section 62 (or the radiation detection section 63).

Although embodiments in which the respective sensor portions 146 of the radiation detection section 62 are used to detect a radiation irradiation timing and an irradiation amount of radiation are explained above, embodiments are not limited thereto. For example, the sensor portions 146 of the radiation detection section 62 may be grouped into two groups, and output signals from one group may be used for detecting the radiation irradiation timing, and output signals from the other group may be employed for detecting the irradiation amount of radiation. Each of the sensor portion groups may be given different characteristics (for example, response speed or sensitivity) according to the application of their output signals.

Although explanation has been given of the embodiment in which both the detection of the radiation irradiation timing to the electronic cassette 32 and the detection of the irradiation amount of radiation are performed, embodiments are not limited thereto. The scope of the present invention includes embodiments in which only one of the detection of irradiation timing or the detection of irradiation amount of radiation is performed.

Explanation has been given above of a configuration in which the electronic cassette 32 is equipped with a function of directly communicating with the console 42 by wireless communication. However, if the electronic cassette 32 only performs detection of the radiation irradiation timing, and does not perform detection of the irradiation amount of radiation (i.e., does not perform monitoring as to whether or not the radiation irradiation amount cumulative value has reached the upper limit value and giving notification to the console 42 if so), it is possible to omit from the electronic cassette 32 the function of direct wireless communication with the console 42. In this case, the cradle may be configured such that transmission of radiographic image data to the console 42 is performed when, for example, the electronic cassette 32 is set in the cradle, and the cradle reading radiographic image data from the electronic cassette 32 and transmitting the radiographic image data to the console 42. Alternatively, transmission of the radiographic image data from the electronic cassette 32 to the console 42 may be performed offline, by using, for example, a memory card.

The entire contents of the disclosure of Japanese Patent Application 2010-166962 are incorporated by reference in the present specification.

Further, all publications, patent applications, and technical standards referred in this specification are incorporated herein by reference to the same extent as if each publication, patent application, or technical standard is specifically and individually indicated to be incorporated by reference.

What is claimed is:

1. A radiation detection panel comprising:
a single light emitting section that absorbs radiation that has been transmitted through an imaging subject and that emits light;
a first detection section that detects light emitted from the light emitting section as an image; and
a second detection section that is formed from an organic photoelectric conversion material and that detects light emitted from the light emitting section,
wherein, the light emitting section, the first detection section and the second detection section are stacked in layers along a radiation incident direction.

2. The radiation detection panel of claim 1, wherein the first detection section and the second detection section are provided on a same support member.

3. The radiation detection panel of claim 1, wherein:
a member present between the single light emitting section and the first detection section, and another member present between the single light emitting section and the second detection section, each member having light transmitting properties enabling transmission of at least a portion of irradiated light.

4. The radiation detection panel of claim 1, wherein the first detection section is formed on a support member that has a plate shape and light transmitting properties, the light emitting section is layered on one face of the plate shaped support member, the second detection section is layered on the other face of the support member, and the support member is disposed such that radiation is incident from a side of the second detection section.

5. The radiation detection panel of claim 1, wherein at least the support member on which the second detection section is disposed is a substrate made with a synthetic resin.

6. The radiation detection panel of claim 1, wherein:
the first detection section is equipped with a plurality of photoelectric conversion elements arrayed two-dimensionally; and
the second detection section is disposed between the light emitting section and the first detection section, and is disposed in a range that does not block light that is emitted from the light emitting section and that is incident at any of the plurality of photoelectric conversion elements.

7. The radiation detection panel of claim 1, further comprising a first controller that performs a first control, of synchronizing a timing of detection of light by the first detection section with a timing of irradiation of radiation at the radiation detection panel, based on a result of light detection by the second detection section.

8. The radiation detection panel of claim 7, wherein:
the first detection section comprises a photoelectric conversion section that converts light emitted from the light emitting section into an electrical signal, and a charge accumulation section that accumulates as charge the electrical signal that has been output from the photoelectric conversion section; and
the first controller causes, as the first control, the first detection section to start accumulation of charge in the charge accumulation section from a state in which an electrical signal that has been previously output from the photoelectric conversion section has not been accumulated as charge in the charge accumulation section, at least in a case in which light emitted from the light emitting section is detected by the second detection section.

9. The radiation detection panel of claim 8, wherein the first controller causes, as the first control, the first detection section to start reading the charge accumulated in the charge accumulation section of the first detection section, if light emitted from the light emitting section is no longer being detected by the second detection section.

10. The radiation detection panel of claim 1, further comprising a second controller that performs a second control, of terminating radiation irradiation from a radiation source if a cumulative irradiation amount of radiation at the radiation detection panel has reached a specific value, based on a result of light detection by the second detection section.

11. The radiation detection panel of claim 10, wherein, as the second control, the second controller computes a cumulative irradiation amount of radiation at the radiation detection panel based on the result of light detection by the second detection section, repeatedly determines whether or not the computation result of the cumulative irradiation amount has reached the specific value, and outputs a signal indicating that the cumulative irradiation amount of radiation has reached the specific value if a determination is made that the computation result of the cumulative irradiation amount has reached the specific value.

12. The radiation detection panel of claim 11, wherein the second controller outputs an instruction signal instructing termination of radiation irradiation from the radiation source to a control device controlling the radiation irradiation from the radiation source, as the signal indicating that the cumulative irradiation amount of radiation has reached the specific value.
